(19) United States
(12) Patent Application Publication
(10) Pub. No.: US 2025/0091205 A1
(43) Pub. Date: Mar. 20, 2025

(54) ROBOT SYSTEM, METHOD OF CONTROLLING THE ROBOT SYSTEM, MOVING STAND, METHOD OF CONTROLLING THE MOVING STAND, METHOD OF MANUFACTURING PRODUCTS, AND RECORDING MEDIUM

(71) Applicant: CANON KABUSHIKI KAISHA, Tokyo (JP)

(72) Inventors: TOMOTAKA ABE, Kanagawa (JP); AKIRA YAJIMA, Saitama (JP); RYOTA OKAZAKI, Kanagawa (JP); MASAKAZU TAKAHASHI, Tokyo (JP); KENJI SHINO, Kanagawa (JP); YUSAKU MOTONAGA, Tokyo (JP)

(21) Appl. No.: 18/885,119

(22) Filed: Sep. 13, 2024

(30) Foreign Application Priority Data
Sep. 20, 2023 (JP) 2023-153958

(51) Int. Cl. B25J 9/16; B25J 9/00

(52) U.S. Cl. CPC B25J 9/1633; B25J 9/0009

(57) ABSTRACT

A robot system includes a robot, and a moving stand including a plurality of legs configured to contact a floor or a ground, and an installation portion on which the robot is installed. At least one of the plurality of legs includes a holding-force changing portion configured to change fixing holding-force between the at least one of the plurality of legs and the floor or the ground in accordance with state of the robot.

### BACKGROUND OF THE INVENTION

### Field of the Invention

The present invention relates to a robot system, a method of controlling the robot system, a moving stand, a method of controlling the moving stand, a method of manufacturing products, and a recording medium.

### Description of the Related Art

In a factory or the like where products are manufactured in low volumes, a plurality of robot apparatuses becomes necessary in a manufacturing line and the operating time of each robot apparatus is shortened if the robot apparatuses for manufacturing products are installed on a floor. For this reason, it is desired that the operating time of each robot apparatus be increased by making it possible to move the robot apparatus and cause the robot apparatus to work in each place, and that the costs be reduced by reducing the number of the robot apparatuses. However, in a case where a robot apparatus is moved, if the robot apparatus is not stabilized in a place to which the robot apparatus has been moved, the robot apparatus cannot perform work with high accuracy. As countermeasures to this, a variety of configurations for the movable robot apparatus is proposed for stabilizing the stand on which the robot apparatus is mounted. For example, Japanese Patent Application Publication No. 2022-91213 (see FIGS. 2 and 3) proposes a configuration for stabilizing the stand on which the robot apparatus is mounted.

In Japanese Patent Application Publication No. 2022-91213, the stand on which a robot body is mounted includes adjuster arms, each of which includes a caster and can expand and contract. In addition, Japanese Patent Application Publication No. 2013-166197 proposes a configuration in which the stand is fixed to a work desk fixed to the floor, by using a clamp. In addition, Japanese Patent Application Publication No. 2020-82233 proposes a configuration in which the stand is fixed to the floor by inserting a positioning pin into an insertion hole formed in the floor.

### SUMMARY OF THE INVENTION

According to a first aspect of the present invention, a robot system includes a robot, and a moving stand including a plurality of legs configured to contact a floor or a ground, and an installation portion on which the robot is installed. At least one of the plurality of legs includes a holding-force changing portion configured to change fixing holding-force between the at least one of the plurality of legs and the floor or the ground in accordance with state of the robot.

According to a second aspect of the present invention, a method of controlling a robot system, the method includes providing a robot system including a robot, a moving stand including a plurality of legs which is configured to contact a floor or a ground, and an installation portion on which the robot is installed, a control portion, and a holding-force changing portion disposed in at least one of the plurality of legs and configured to change fixing holding-force between the at least one of plurality of legs and the floor or the ground, and controlling, by the control portion, a magnitude of the fixing holding-force of the holding-force changing portion in accordance with state of the robot.

According to a third aspect of the present invention, a moving stand on which a robot is installed and that is configured to move with respect to a floor or a ground, the moving stand includes a plurality of legs configured to contact the floor or the ground. At least one of the plurality of legs includes a holding-force changing portion configured to change fixing holding-force between at least one of the plurality of legs and the floor or the ground in accordance with state of the robot.

According to a fourth aspect of the present invention, A method of controlling a moving stand configured to move with respect to a floor or the ground, the method includes providing the moving stand including a plurality of legs configured to contact the floor or a ground, an installation portion on which a robot is installed, and a holding-force changing portion disposed in at least one of the plurality of legs and configured to change fixing holding-force between at least one of the plurality of legs and the floor or the ground, and controlling, by the control portion, a magnitude of the fixing holding-force of the holding-force changing portion in accordance with state of the robot.

Further features of the present invention will become apparent from the following description of exemplary embodiments with reference to the attached drawings.

### BRIEF DESCRIPTION OF THE DRAWINGS

FIG. 1 is a diagram illustrating a moving robot system of a first embodiment.

FIG. 2 is a diagram illustrating a state where the moving robot system of the first embodiment has been moved to a work position.

FIG. 3 is a bottom perspective view illustrating a moving stand of the first embodiment.

FIG. 4A is a diagram illustrating positions in which fixed legs and movable legs are disposed in the moving stand of the first embodiment.

FIG. 4B is a top view illustrating the robot system of the first embodiment.

FIG. 5 is a perspective view illustrating a movable leg of the first embodiment.

FIG. 6 is a perspective view illustrating casters and their lifting-and-lowering mechanism of the moving stand of the first embodiment.

FIG. 7 is a diagram illustrating movement of the moving stand of the first embodiment.

FIG. 8A is a bottom view illustrating the robot system in a state where a robot arm of the first embodiment is positioned at a center of the moving stand.

FIG. 8B is a bottom view illustrating the robot system in a state where the robot arm of the first embodiment has been moved from the center of the moving stand toward an X1 direction.

FIG. 8C is a bottom view illustrating the robot system in a state where the robot arm of the first embodiment has been moved from the center of the moving stand toward an X2 direction.

FIG. 9A is a diagram illustrating positions in which fixed legs and movable legs are disposed in a first pattern.

FIG. 9B is a diagram illustrating positions in which fixed legs and movable legs are disposed in a second pattern.

FIG. 9C is a diagram illustrating positions in which fixed legs and a movable leg are disposed in a third pattern

FIG. 9D is a diagram illustrating positions in which a fixed leg and movable legs are disposed in a fourth pattern.

FIG. 9E is a diagram illustrating positions in which fixed legs and movable legs are disposed in a fifth pattern.

FIG. 9F is a diagram illustrating positions in which fixed legs and movable legs are disposed in a sixth pattern.

FIG. 10A is a diagram illustrating positions in which fixed legs, movable legs, and gyrosensors of the first embodiment are disposed.

FIG. 10B is a block diagram illustrating a configuration of a first movable leg and a second movable leg of the first embodiment.

FIG. 10C is a block diagram illustrating a control system of the movable legs of the first embodiment.

FIG. 11 is a flowchart illustrating posture control of the first embodiment.

FIG. 12A is a diagram illustrating positions in which fixed legs, movable legs, and gyrosensors of a second embodiment are disposed.

FIG. 12B is a block diagram illustrating a control system of the movable legs of the second embodiment.

FIG. 13 is a flowchart illustrating posture control of the second embodiment.

FIG. 14A is a diagram illustrating positions in which fixed legs, movable legs, and a gyrosensor of a third embodiment are disposed.

FIG. 14B is a block diagram illustrating a control system of the movable legs of the third embodiment.

FIG. 15 is a flowchart illustrating posture control of the third embodiment.

FIG. 16A is a diagram illustrating positions in which fixed legs, movable legs, and a gyrosensor of a fourth embodiment are disposed.

FIG. 16B is a block diagram illustrating a configuration of a first movable leg, a second movable leg, and a third movable leg of the fourth embodiment.

FIG. 17 is a block diagram illustrating a control system of the movable legs of the fourth embodiment.

FIG. 18 is a flowchart illustrating posture control of the fourth embodiment.

FIG. 19A is a diagram illustrating positions in which fixed legs, movable legs, and a gyrosensor of a fifth embodiment are disposed.

FIG. 19B is a block diagram illustrating a control system of the movable legs of the fifth embodiment.

FIG. 20 is a flowchart illustrating initial setting control and correction control of the fifth embodiment.

### DESCRIPTION OF THE EMBODIMENTS

In the configuration which is described in Japanese Patent Application Publication No. 2022-91213 and in which the stand is fixed by manually adjusting the adjuster, it takes time to fix the stand and install the robot apparatus. In addition, in the configuration which is described in Japanese Patent Application Publication No. 2013-166197 and in which the stand is manually fixed to a work desk by using a clamp, it also takes time to fix the stand and install the robot apparatus. In addition, in the configuration which is described in Japanese Patent Application Publication No. 2020-82233 and in which the stand is fixed by inserting the pin into the insertion hole, it also takes time to position the stand and the insertion hole with high accuracy and install the robot apparatus. In the configurations described in Japanese Patent Application Publication Nos. 2022-91213, 2013-166197, and 2020-82233, it is intended that the stand is firmly fixed to the floor. However, the stand cannot firmly be fixed to the floor to the extent that the robot body is fixed to the floor, so that the stand is caused to vibrate by the motion of the robot arm. As a result, it takes additional time to teach the robot apparatus the work to be performed after the installation, for causing the robot apparatus to perform the work with high accuracy.

The present embodiments provides a robot system, a method of controlling the robot system, a moving stand, a method of controlling the moving stand, a method of manufacturing products, a program, and a recording medium that can shorten the time required for the start of work in a case where the robot system is moved.

### First Embodiment

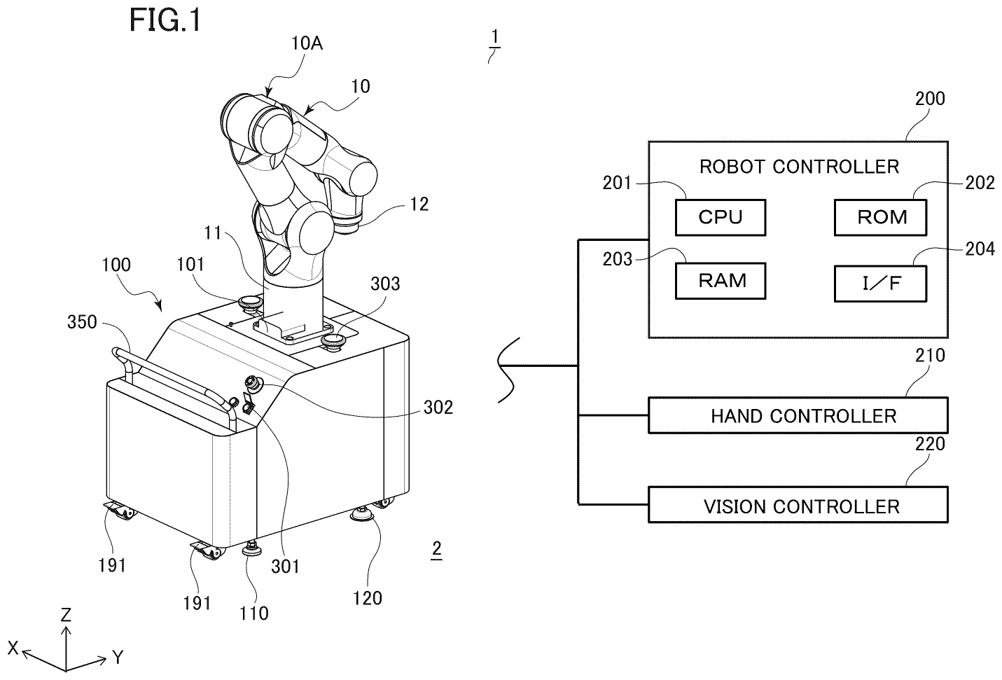

Hereinafter, a first embodiment for embodying the present invention will be described with reference to FIGS. 1 to 11.

### Schematic Configuration of Robot System

First, a schematic configuration of a moving robot system of the first embodiment will be described with reference to FIG. 1. FIG. 1 is a diagram illustrating the moving robot system of the first embodiment. Note that the direction toward which the leading end of a robot arm 10A of a robot system 1 faces is defined as a front direction, the right-and-left direction of the robot system 1 is defined as an X direction, the front-and-back direction orthogonal to the X direction is defined as a Y direction, and the up-and-down direction orthogonal to the X direction and the Y direction is defined as a Z direction. The X direction, the Y direction, and the Z direction constitute the coordinate system of the robot system 1, and are directions that move together with the robot system 1. Thus, if a floor 2 forms a flat horizontal plane, the Z direction remains the up-and-down direction even if the robot system 1 moves. Note that the floor 2 may be the ground.

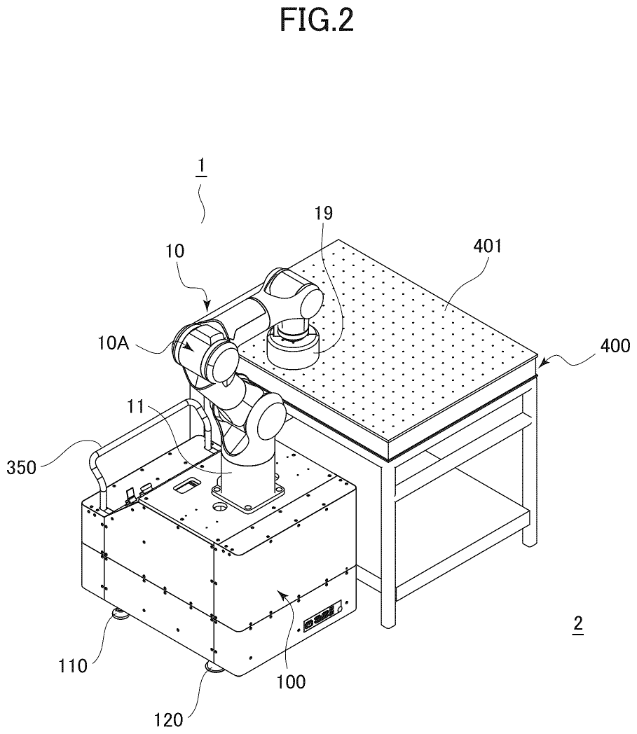

As illustrated in FIG. 1, the moving robot system 1 mainly includes a moving stand 100 that includes casters 191, and a robot apparatus 10 that is disposed and mounted on the moving stand 100. The robot apparatus 10 includes a base 11 that is disposed on an installation portion 101 of the moving stand 100, and the robot arm 10A that is disposed on and supported by the base 11 and that serves as a robot body (or simply a robot). For example, the robot arm 10A of the present embodiment is a six-axis articulated manipulator. In addition, a robot hand 19 (see FIG. 2) that serves as an end effector can be attached to a link 12 of the robot arm 10A that is disposed at the distal end of the robot arm 10A.

In addition, the robot system 1 includes a robot controller 200 that controls the robot apparatus 10, a hand controller 210 that controls the robot hand 19, and a vision controller 220 that controls a camera (not illustrated) attached to the robot hand 19. These controllers are accommodated in the moving stand 100. Note that the moving stand 100 also accommodates a programmable logic controller (PLC) and a uninterruptible power system (UPS) (both not illustrated).

The robot controller 200 includes a computer including a microprocessor element or the like, and controls each component of the robot apparatus 10 and the moving stand 100. The computer included in the robot controller 200 includes, for example, a CPU 201 that serves as a control portion, a ROM 202 that stores a program used for controlling each component, a RAM 203, and a communication interface (denoted by I/F in FIG. 1) 204. Of the above-described components, the RAM 203 is used for temporarily storing data, such as teach point data and control command, created by operating a teaching pendant (not illustrated) or the like. Note that the program for controlling each component may be recorded in a recording medium, and may be installed in the ROM 202, from the recording medium. In addition, the communication interface 204 may be connected with another computer apparatus (e.g., a PC or a server) that can edit the robot program.

The CPU 201 receives the teach point data, sent by using a teaching pendant or the like, from the communication interface 204. The CPU 201 then creates the trajectory data of each shaft (i.e., each link) of the robot apparatus 10, based on the teach point data received by the CPU 201; and sends the trajectory data to the robot apparatus 10, as a control target value, via the communication interface 204. With this operation, the robot apparatus 10 can cause the robot hand 19, attached to the distal end of the robot arm 10A, to perform work on a workpiece, which is an object on which the robot hand 19 is operated.

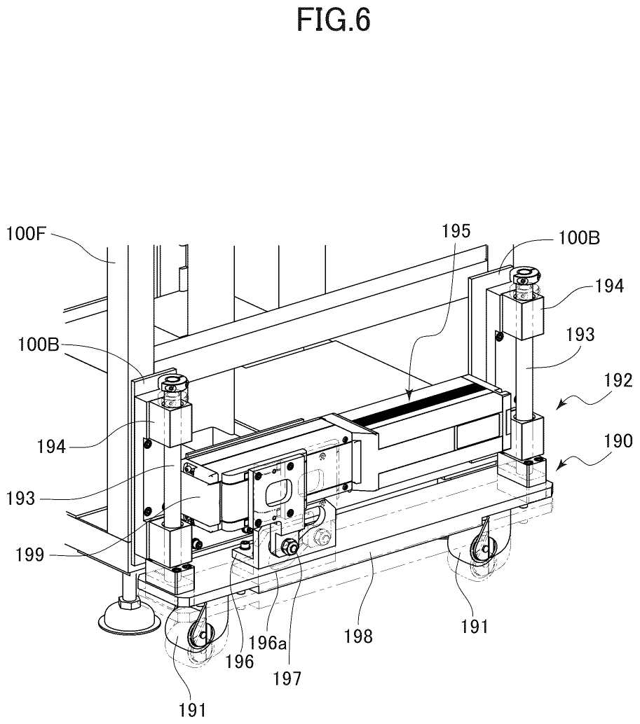

On the other hand, the moving stand 100 can move to a predetermined position, while rolling on the floor 2, by the casters 191 that can be lifted and lowered as described in detail below. The moving stand 100 accommodates a frame portion 100F (see FIG. 6); and the installation portion 101, on which the above-described base 11 is disposed, is disposed on the frame portion 100F. In addition, a plurality of (three in the first embodiment) fixed legs 110 is fixed to the frame portion 100F, and the length of the fixed legs 110 in the up-and-down direction is not changed with respect to the frame portion 100F. The moving stand 100 further includes a plurality of (two in the first embodiment) movable legs 120 which is attached to the frame portion 100F and whose length in the up-and-down direction can be changed with respect to the frame portion 100F. As described in detail below, the fixed legs 110 and the movable legs 120 can contact the floor 2, depending on the lifting and lowering of the casters 191.

In addition, the moving stand 100 includes a lifting-and-lowering switch 301 disposed on a top portion of the moving stand 100 and used for controlling a below-described lifting-and-lowering mechanism 195 and changing the height of the casters 191 in the up-and-down direction. In addition, the moving stand 100 includes a handle 350 disposed on a top portion of the moving stand 100 and used for an operator to hold the handle 350 and move the moving stand 100. In addition, the moving stand 100 includes an emergency stop button 302 disposed on a top portion of the moving stand 100 and used for stopping the operation of the robot arm 10A in an abnormal condition.

In addition, the moving stand 100 includes an area sensor 303 disposed on a top portion of the moving stand 100 and used for recognizing the surrounding environment. The area sensor 303 is connected to the robot controller 200, and if the CPU 201 determines depending on a detection result from the area sensor 303 that the moving stand 100 is approaching an object around the moving stand 100 and may collide with the object when the moving stand 100 is moving, the CPU 201 activates a brake (not illustrated) and prevents the collision of the moving stand 100. In addition, if the area sensor 303 detects a human near the robot system 1, the CPU 201 controls the robot arm 10A and lowers the upper limit of the motion speed of the robot arm 10A. That is, the robot arm 10A operates at a maximum speed when working alone; and operates at a lowered speed, in consideration of safety, when performing collaborative work at a position near a human.

### Work of Robot System

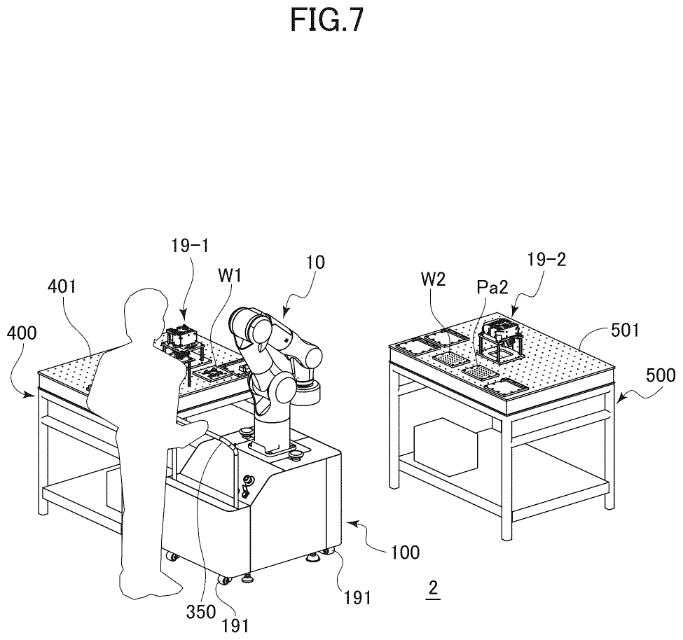

Next, the work performed by the robot system 1 of the first embodiment will be described with reference to FIGS. 2 to 7. FIG. 2 is a diagram illustrating a state where the moving robot system of the first embodiment has been moved to a work position. FIG. 7 is a diagram illustrating the movement of the moving stand of the first embodiment.

As illustrated in FIGS. 2 and 7, a fixed stand 400 is fixed to the floor 2 for example, and the robot system 1 moves to a position in front of the fixed stand 400 and performs assembly work, as first work. As illustrated in FIG. 7, on a workbench 401 of the fixed stand 400, components, such as a connector (not illustrated), a board W1, and a robot hand 19-1, are disposed. The board W1 is a workpiece to which the connector is to be assembled by inserting the connector in the workpiece. The robot hand 19-1 performs the assembly work of the connector. That is, the robot system 1 causes the robot apparatus 10 to perform the assembly work of the connector, in a state where the moving stand 100 is moved to a position in front of the fixed stand 400 and positioned at the position.

In the assembly work of the connector, first, the robot hand 19-1 placed on a hand replacement stand (not illustrated) is attached to the link 12 (see FIG. 1) disposed at the distal end of the robot arm 10A. Then the robot hand 19-1 is moved, and holds the connector. The robot hand 19-1 that is holding the connector is then moved to a position above the board W1 fixed to the workbench 401 via a fixing jig. Then the connector held by the robot hand 19-1 is inserted in the board W1, and assembled to the board W1. These operations are repeated, and a plurality of connectors is assembled to the board W1. Thus, when the assembly work is completed, the production of the product is completed accordingly. In addition, after the completion of the assembly work of the connector, the robot hand 19-1 is replaced on the hand replacement stand, and removed from the robot arm 10A. Then, the robot arm 10A is moved to a center of the moving stand 100 for the movement of the robot system 1.

Note that the robot hand 19-1 includes a camera (not illustrated). Thus, the robot controller 200 performs the positioning by performing the visual servo control on the robot arm 10A, by using images captured by the vision controller 220. That is, by performing the visual servo control, the robot controller 200 controls the position and posture of the robot arm 10A while checking the position of the robot hand 19-1, the position of the connector, and the position of the board W1. With this operation, after the robot system 1 is moved, the robot hand 19 can perform the assembly work of the connector while automatically performing the positioning, even if the moving stand 100 (or the robot arm 10A) and the fixed stand 400 are not positioned with respect to each other with high accuracy.

In addition, as an example, a fixed stand 500 is fixed to the floor 2 at a position different from the position of the fixed stand 400, and the robot system 1 moves to a position in front of the fixed stand 500 and performs assembly work, as second work. On a workbench 501 of the fixed stand 500, components, such as a pin stand Pa2, an assembly workpiece W2, and a robot hand 19-2, are disposed. On the pin stand Pa2, pins (not illustrated) that are components (parts) are placed. The assembly workpiece W2 is a workpiece to which the pin is assembled by inserting the pin into a hole portion (not illustrated) of the workpiece. The robot hand 19-2 performs the assembly work of the pin. That is, the robot system 1 causes the robot apparatus 10 to perform the assembly work of the pin, in a state where the moving stand 100 is moved to a position in front of the fixed stand 500 and positioned at the position.

In the assembly work of the pin, first, the robot hand 19-2 placed on a hand replacement stand (not illustrated) is attached to the link 12 (see FIG. 1) disposed at the distal end of the robot arm 10A. Then the robot hand 19-2 is moved, and holds the pin placed on the pin stand that serves as a workpiece supply portion. The robot hand 19-2 that is holding the pin is then moved to a position above the assembly workpiece W2 fixed to the workbench 501 via a fixingjig. Then the pin held by the robot hand 19-2 is inserted into a hole portion of the assembly workpiece W2, and assembled to the assembly workpiece W2. These operations are repeated, and a plurality of pins is assembled to the assembly workpiece W2. Thus, when the assembly work is completed, the production of the product is completed accordingly. In addition, after the completion of the assembly work of the pin, the robot hand 19-2 is replaced on the hand replacement stand, and removed from the robot arm 10A. Then, the robot arm 10A is moved to a center of the moving stand 100 for the movement of the robot system 1.

Note that the robot hand 19-2 also includes a camera (not illustrated). Thus, the robot controller 200 performs the positioning by performing the visual servo control on the robot arm 10A, by using images captured by the vision controller 220. That is, by performing the visual servo control, the robot controller 200 controls the position and posture of the robot arm 10A while checking the position of the robot hand 19-2, the position of the pin, and the position of the assembly workpiece W2. With this operation, after the robot system 1 is moved, the robot hand 19 can perform the assembly work of the pin while automatically performing the positioning, even if the moving stand 100 (or the robot arm 10A) and the fixed stand 400 are not positioned with respect to each other with high accuracy.

As described above, the robot system 1 can perform different types of work by moving to the respective positions. As illustrated in FIG. 7, in a case where the robot system 1 is moved, the casters 191 are lowered so as to project downward from the fixed legs 110 and the movable legs 120 (see FIG. 2) and contact the floor 2, by the lifting-and-lowering mechanism 195 that will be described in detail below. With this operation, a worker can move the moving stand 100 while handling the handle 350. In addition, as illustrated in FIG. 2, the worker moves the moving stand 100 to a position in front of the fixed stand 400 on which the robot system 1 performs work, and positions the moving stand 100 at the position. In this case, the casters 191 are lifted so as to retract upward from the fixed legs 110 and the movable legs 120 (see FIG. 2), by the below-described lifting-and-lowering mechanism 195, so that the fixed legs 110 and the movable legs 120 contact the floor 2. With this operation, the position of the moving stand 100 on the floor 2 is positioned with respect to the fixed stand 400, and the moving stand 100 is fixed to the floor 2.

### Configuration of Fixed Leg, Movable Leg, and Caster

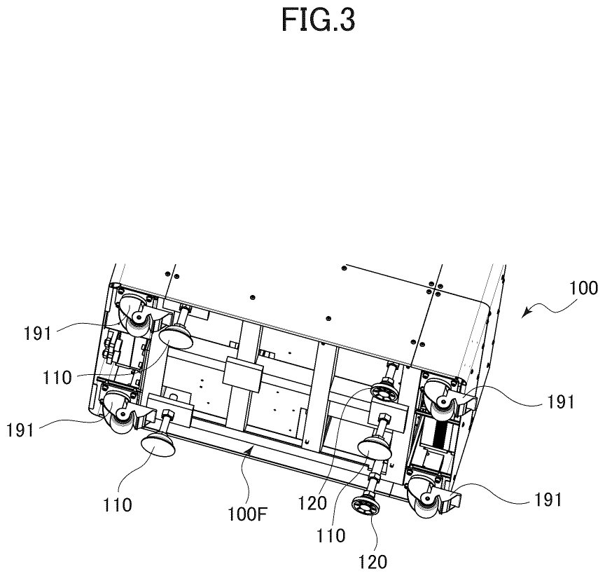

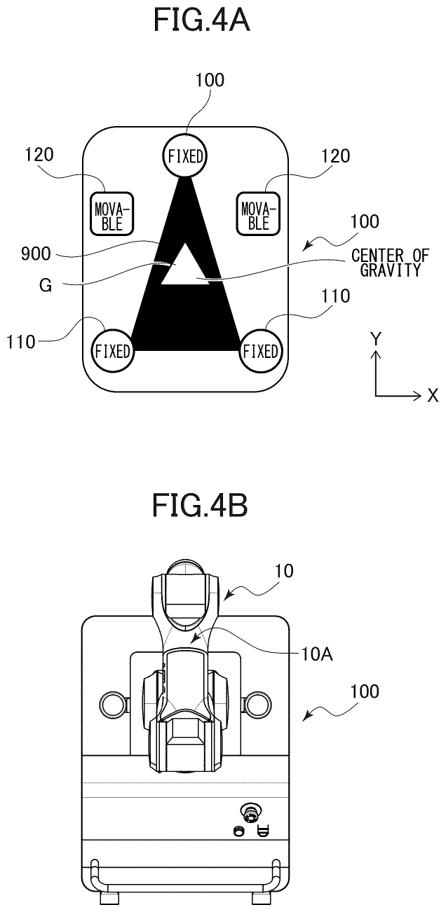

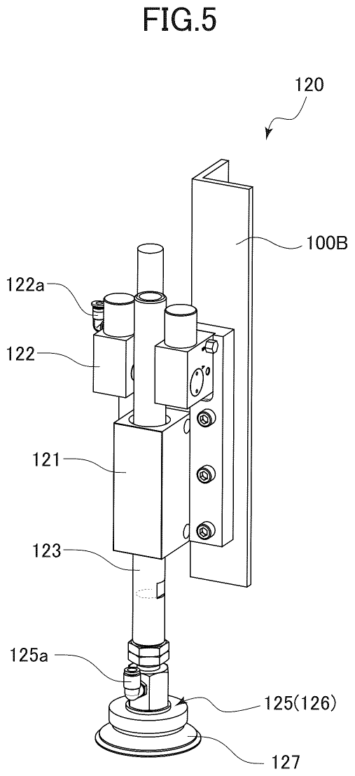

Next, a configuration of each of the fixed legs 110 and the movable legs 120 of the moving stand 100 of the first embodiment will be described with reference to FIGS. 3 to 5. FIG. 3 is a bottom perspective view illustrating the moving stand of the first embodiment. FIG. 4A is a diagram illustrating positions in which the fixed legs and the movable legs are disposed in the moving stand of the first embodiment. FIG. 4B is a top view illustrating the robot system of the first embodiment. FIG. 5 is a perspective view illustrating a movable leg of the first embodiment. FIG. 6 is a perspective view illustrating the casters and their lifting-and-lowering mechanism of the moving stand of the first embodiment.

As illustrated in FIG. 3, on a bottom portion of the moving stand 100, four casters 191 that are lifted and lowered, three fixed legs 110, and two movable legs 120 are disposed. The height of the three fixed legs 110 with respect to the frame portion 100F in the up-and-down direction is fixed, and the height of the two movable legs 120 with respect to the frame portion 100F in the up-and-down direction can be changed. That is, in the first embodiment, the plurality of legs includes the three fixed legs 110 and the two movable legs 120, which are three or more, and five in total.

As illustrated in FIG. 4A, the three fixed legs 110 are arranged such that one fixed leg 110 is disposed at a center on one side in the Y direction, which is the front-and-back direction of the moving stand 100, and that the other two fixed legs 110 are disposed at both ends on the other side in the Y direction. A FIG. 900 formed by connecting the fixed legs 110, which serve as apexes, with a line is a triangle. As illustrated in FIG. 4B, the robot arm 10A (or the installation portion 101 illustrated in FIG. 1) is disposed at a substantially central portion of the moving stand 100 in the front-and-back direction and the lateral direction of the moving stand 100. Thus, as illustrated in FIG. 4A, a center G of gravity of the robot arm 10A is located inside the FIG. 900. In addition, the two movable legs 120 are disposed outside the FIG. 900. As described in detail below, if the center G of gravity moves to the outside of the FIG. 900 due to the change in position and posture of the robot arm 10A, the load will be applied onto the movable legs 120.

### Configuration of Movable Leg

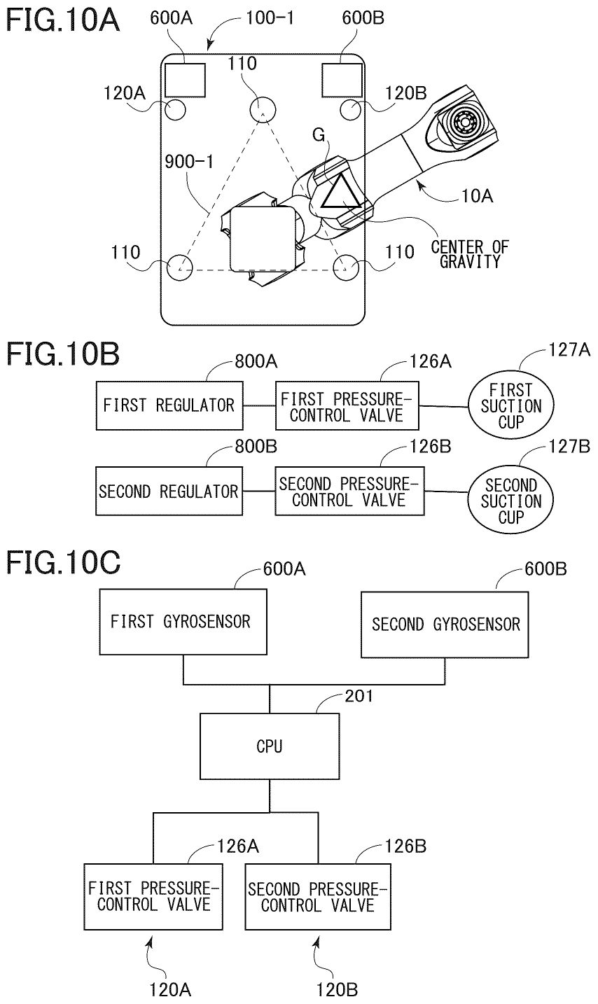

Next, a detailed configuration of the movable legs 120 will be described. As illustrated in FIG. 5, the movable leg 120 is attached to a bracket 100B that is fixed to the frame portion 100F (see FIG. 3) disposed in the moving stand 100. The movable leg 120 includes a guide 121 that accommodates an oilless bushing (not illustrated), a shaft 123, a brake unit 122, and an air sticking portion 125 that serves as a holding-force changing portion. The shaft 123 is supported by the oilless bushing of the guide 121 such that the shaft 123 can move freely in the axial direction (i.e., the up-and-down direction). The brake unit 122 may be a LinearClamper-Zee. In this case, the shaft 123 can be clamped by the pressure of the air supplied from an air joint 122a. At an end portion of the shaft 123, the air sticking portion 125 which sticks to the floor 2 and whose sticking force can be changed is disposed. The air sticking portion 125 includes a pressure control valve 126 and a suction cup 127. The pressure control valve 126 is connected between an air joint 125a and a regulator 800 (see FIG. 10), and controls the pressure so that the pressure can be adjusted. The pressure of the interior of the suction cup 127 is adjusted by the pressure control valve 126.

Next, the operation for adjusting the length of the movable leg 120 will be described. For example, the shaft 123 of the movable leg 120 falls due to the self weight of the shaft 123 and contacts the surface of the floor 2 after the fixed leg 110 contacts the surface of the floor 2. After the shaft 123 of the fixed leg 110 contacts the surface of the floor 2, the CPU 201 of the robot controller 200 causes the brake unit 122 to clamp the shaft 123 (that is, fixes the length of the shaft 123), by supplying the air to the air joint 122a of the brake unit 122 via an electromagnetic valve (not illustrated). Note that the adjustment of the length of the movable leg 120 is not limited to the adjustment performed by using the shaft 123 and the brake unit 122. For example, the adjustment may be performed by using an air cylinder or a ball screw.

Next, the sticking operation which is performed by the air sticking portion 125 and by which the movable leg 120 sticks to the floor 2 will be described. In a case where the movable leg 120 is caused to stick to the floor 2 by the air sticking portion 125, the pressure (negative pressure) is applied from the regulator 800 (see FIG. 10) to the air joint 125a via the pressure control valve 126 that is a proportional electromagnetic valve. That is, the pressure of the interior of the suction cup 127 is changed by adjusting and controlling the amount of communication of an opening of the pressure control valve 126, so that the sticking force (i.e., the fixing holding-force) between the suction cup 127 and the floor 2 is changed and adjusted. Note that the pressure control valve 126 may not be a valve that performs the proportional control (i.e., the duty control) on a proportional electromagnetic valve. For example, the pressure control valve 126 may be a valve that performs the PWM control on an ON/OFF electromagnetic valve.

As described above, the length of the movable legs 120 in the up-and-down direction can be adjusted automatically. For example, in the moving stand which is described in Japanese Patent Application Publication No. 2022-91213 and in which the casters and the adjusters are used, since the adjusters disposed in the vicinity of the four casters are adjusted by a worker in each position at which the moving stand is installed, it takes time for the adjustment in the installation of the moving stand. In contrast, in the moving stand 100 of the present embodiment, since the three fixed legs 110 and the two movable legs 120 whose length is automatically changed are used, the posture of the moving stand 100 can be stabilized in a short time.

### Cater Mechanism

Next, a caster mechanism 190 that lifts and lowers the casters 191 will be described. As illustrated in FIG. 6, the caster mechanism 190 may be disposed in each of two positions: a position on the front side of the moving stand 100 and a position on the back side of the moving stand 100. Each caster mechanism 190 is attached to a corresponding one of two brackets 100B fixed to the frame portion 100F, which is disposed in the moving stand 100.

Specifically, as illustrated in FIG. 6, the caster mechanism 190 includes a caster base 198 to which two casters 191 are attached, a guide portion 192 which supports the caster base 198 such that the caster base can freely move in the up-and-down direction, and a lifting-and-lowering mechanism 195 that lifts and lowers the caster base 198 in the up-and-down direction. The guide portion 192 includes a bearing portion 194 which is attached to a corresponding bracket 100B, and a guide shaft 193 which is guided by the bearing portion 194 such that the guide shaft 193 can move freely in the up-and-down direction. In addition, the above-described caster base 198 is fixed to and supported by the guide shaft 193.

On the other hand, the lifting-and-lowering mechanism 195 that serves as a switching mechanism includes a driving stage 199 that is supported by two brackets 100B such that the driving stage 199 can move in a horizontal direction. The lifting-and-lowering mechanism 195 also includes a cam follower 197 which is fixed to and supported by the driving stage 199, and a cam plate 196 in which the cam follower 197 is engaged with a guide groove 196a. The driving stage 199 includes a driving motor (not illustrated), and if the driving motor is driven by operating the above-described lifting-and-lowering switch 301 (see FIG. 1), the driving stage 199 is moved in the horizontal direction. If the cam follower 197 is moved together with the driving stage 199 in the horizontal direction, the cam follower 197 pushes the guide groove 196a, and thereby moves the cam plate 196 fixed to the caster base 198, in the up-and-down direction. With this operation, the caster base 198 is lifted and lowered in the up-and-down direction, together with the two casters 191. Thus, the lifting-and-lowering mechanism 195 can switch the position of the casters 191 between the position at which the casters 191 project downward from the fixed legs 110, and the position at which the casters 191 are retracted upward from the fixed legs 110.

Note that the description has been made, in the present embodiment, for the case where the casters 191 are lifted and lowered by using the caster mechanism 190. However, the present disclosure is not limited to this. For example, the caster base or the casters themselves may be lifted and lowered by using another driving source, such as an air cylinder. Movement of Moving Stand and Contact between Moving Stand and Floor As illustrated in FIG. 7, the moving stand 100 configured as described above can be moved by an operator such that the casters 191 contact the floor 2 and roll on the floor 2. In a case where the moving stand 100 is installed in a work place to which the moving stand 100 has been moved, the casters 191 are lifted by the above-described caster mechanism 190. As a result, the moving stand 100 is brought into contact with the floor 2 by basically the three fixed legs 110. Since the three fixed legs 110 contact the floor 2, the moving stand 100 contacts a single contact plane. That is, if the surface (i.e., the floor surface) of the floor 2 is substantially flat, the three fixed legs 110 contact the surface of the floor 2, so that the posture of the moving stand 100 is stabilized.

Note that if the floor is not flat but uneven, any one of the movable legs 120 may contact the floor earlier than any one of the three fixed legs 110 contacts the floor, before all the three fixed legs 110 contact the floor. That is, by adjusting the length of the movable legs 120 that can be adjusted, three or more legs including the fixed legs 110 and movable legs 120 can be brought into contact with the floor. As a result, the posture of the moving stand 100 can be stabilized.

In addition, if the floor has a surface that is sloped, the gravity direction of the moving stand 100 is not equal to the axial direction of the fixed legs 110 even if the all the three fixed legs 110 contact the floor. In this case, the posture of the moving stand 100 is not stable. However, since the length of each of the movable legs 120 can be adjusted (in accordance with the sloped surface), three or more legs including the fixed legs 110 can contact the floor. As a result, the posture of the moving stand 100 can be stabilized.

Movement of Center of Gravity by driving Robot Arm and Change in Fixing Holding-Force of Movable Legs

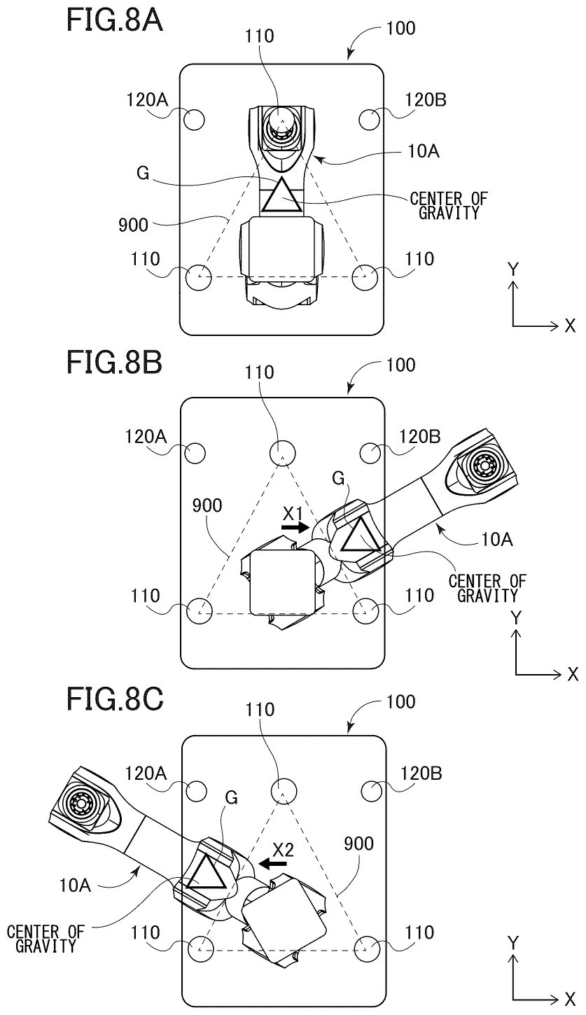

Next, the movement of the center of gravity caused by the change in the position and posture of the robot arm 10A caused by driving the robot arm 10A, and the change in the fixing holding-force of the movable legs 120 to the floor 2 will be described with reference to FIGS. 8A to 8C. FIG. 8A is a bottom view illustrating the robot system in a state where the robot arm of the first embodiment is positioned at a center of the moving stand. FIG. 8B is a bottom view illustrating the robot system in a state where the robot arm of the first embodiment has been moved from the center of the moving stand toward an X1 direction. FIG. 8C is a bottom view illustrating the robot system in a state where the robot arm of the first embodiment has been moved from the center of the moving stand toward an X2 direction.

As illustrated in FIG. 8A, in a case where the robot system 1 is moved by using the moving stand 100 as an example, the robot arm 10A is controlled so that the position and posture of the robot arm 10A is positioned at an initial position (i.e., a home position). Thus, in a state immediately after the robot system 1 is moved, and the three fixed legs 110, a movable leg 120A, and a movable leg 120B are brought into contact with the floor 2 by lifting the casters 191, the center G of gravity of the robot arm 10A is located inside the FIG. 900 formed by connecting the three fixed legs 110 with a line. Thus, since the robot system 1 is supported by the three fixed legs 110, there is less possibility that the robot system 1 will fall over. In addition, in this state, each of the movable legs 120A and 120B receives the normal reaction force into which the self weight of the robot system 1 is substantially distributed to the five legs.

As illustrated in FIG. 8B, if the robot system 1 starts work as described above, the robot arm 10A is controlled and driven, and the position and posture of the robot arm 10A is changed. For example, the position of the center G of gravity moves from the center toward the X1 direction, and is located outside the FIG. 900. As a result, since the center G of gravity is located outside the FIG. 900, there is a possibility that the robot system 1 will fall over. However, when the center G of gravity moves toward the X1 direction, force β is applied downward to the movable leg 120B, in addition to the above-described normal reaction force (the force β is applied to the movable leg 120B by the shift of the position of the center of gravity, and is larger than zero). Thus, the fixing holding-force to the floor 2 is increased, so that it becomes possible to prevent the robot system 1 from falling over. In addition, force α is applied upward to the movable leg 120A, in addition to the above-described normal reaction force (the force α is applied to the movable leg 120A by the shift of the position of the center of gravity, and is smaller than zero). Thus, the force is applied to the movable leg 120A in a direction in which the movable leg 120A floats up from the floor 2. However, since the movable leg 120A is caused to stick to the floor 2 and fixed to the floor 2 by the air sticking portion 125 of the movable leg 120A, the fixing holding-force that resists the moment caused by the movement of the center G of gravity is produced, and it becomes possible to prevent the robot system 1 from further falling over.

As illustrated in FIG. 8C, the position and posture of the robot arm 10A is further changed, and the position of the center G of gravity moves from the center toward the X2 direction and is located outside the FIG. 900. In this case, the sticking of the air sticking portion 125 of the movable leg 120A is stopped, or the sticking force of the air sticking portion 125 of the movable leg 120A is decreased. On the other hand, the sticking force between the movable leg 120B and the floor 2 is increased by the air sticking portion 125 of the movable leg 120B. With this operation, the fixing holding-force that resists the moment caused by the movement of the center G of gravity is produced, and it becomes possible to prevent the robot system 1 from falling over.

In this manner, the magnitude of the sticking force of the air sticking portion 125 of the movable leg 120A and the magnitude of the sticking force of the sticking portion 125 of the movable leg 120B are changed such that the magnitude of the sticking force of the air sticking portion 125 of the movable leg 120A and the magnitude of the sticking force of the sticking portion 125 of the movable leg 120B are exchanged with each other in accordance with the movement of the position of the center G of gravity caused by the change in the position and posture of the robot arm 10A and performed such that the position of the center G of gravity moves back and forth in the X direction that is the lateral direction. As a result, the robot system 1 can be prevented from falling over, and in addition to this, it becomes possible to suppress the vibration of the robot system 1, especially in the lateral direction, by changing the fixing holding-force of the movable legs 120A and 120B to the floor 2 in accordance with the movement of the center G of gravity (the fixing holding-force of the movable legs 120A and 120B is produced by the movable legs 120A and 120B sticking to the floor 2). In particular, in a case where the movable legs 120A and 120B are fixed to the floor 2 by a maximum value of the fixing holding-force, although the robot system 1 can be prevented from falling over, it is difficult to suppress the vibration. In the present embodiment, however, since the fixing holding-force of the movable legs 120A and 120B is changed in accordance with the movement of the center G of gravity, the vibration can be suppressed, and the energy required for producing the fixing holding-force can be reduced to the minimum necessary level, compared with the energy produced in a case where the fixing holding-force is maximized.

Note that in the first embodiment, the description has been made for the case where each of the movable legs 120 includes the air sticking portion 125 and the sticking force (i.e., the fixing holding-force), produced by the air, to the floor 2 is changed. However, the present disclosure is not limited to this. For example, if the floor 2 is made of a magnetic material, the sticking force (i.e., the fixing holding-force) to the floor 2 may be changed by using the electromagnetic force or the like. Furthermore, any force other than the electromagnetic force is applicable as long as the force can change the sticking force (i.e., the fixing holding-force).

### Modification of Arrangement Pattern of Fixed Legs and Movable Legs

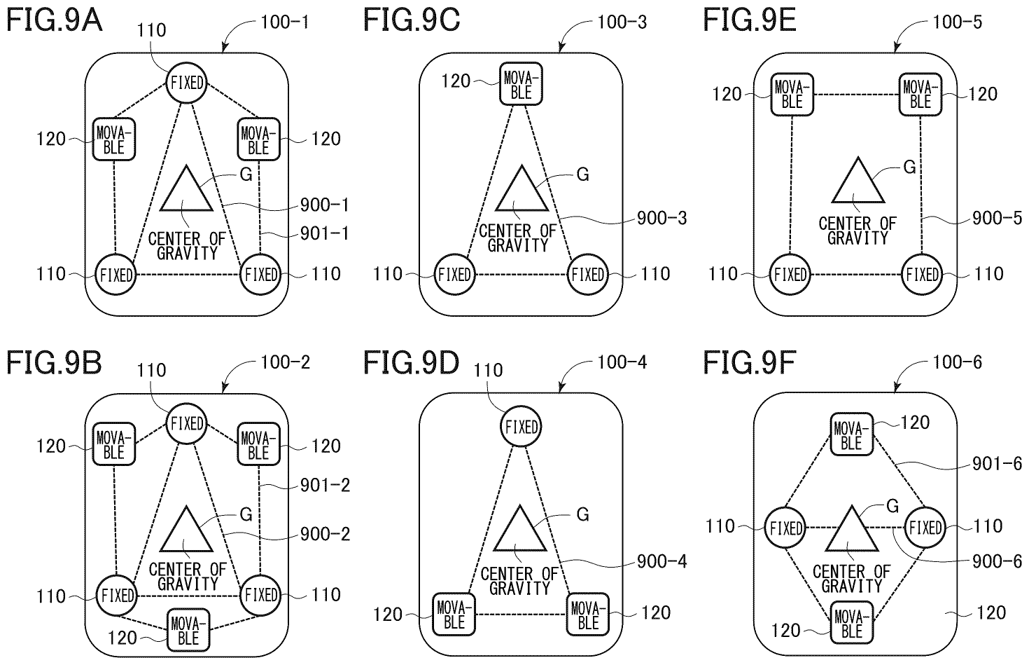

Next, a modification of the arrangement pattern of the fixed legs and the movable legs disposed on the moving stand 100 of the robot system 1 will be described with reference to FIG. 9. FIG. 9A is a diagram illustrating positions in which fixed legs and movable legs are disposed in a first pattern. FIG. 9B is a diagram illustrating positions in which fixed legs and movable legs are disposed in a second pattern. FIG. 9C is a diagram illustrating positions in which fixed legs and a movable leg are disposed in a third pattern. FIG. 9D is a diagram illustrating positions in which a fixed leg and movable legs are disposed in a fourth pattern. FIG. 9E is a diagram illustrating positions in which fixed legs and movable legs are disposed in a fifth pattern. FIG. 9F is a diagram illustrating positions in which fixed legs and movable legs are disposed in a sixth pattern.

FIG. 9A illustrates a moving stand 100-1 that has an arrangement pattern of the fixed legs 110 and the movable legs 120, as a first pattern. The first pattern is the arrangement pattern described in the first embodiment. That is, three fixed legs 110 are arranged such that one fixed leg 110 is disposed at a center in the X direction, on one side in the Y direction, which is the front-and-back direction of the moving stand 100, and that the other two fixed legs 110 are disposed in the vicinity of both ends in the X direction, on the other side in the Y direction. In addition, two movable legs 120 are disposed in the vicinity of both ends in the X direction, with the fixed leg 110 disposed on the one side in the y direction being interposed between the two movable legs 120. Thus, the two movable legs 120 are disposed outside a FIG. 900-1 formed by connecting the three fixed legs 110 with a line. In the arrangement pattern that is the first pattern, a FIG. 901-1 whose outer edge is formed by the three fixed legs 110 and the two movable legs 120 has its area in which the robot system 1 can be prevented from falling over even if the center G of gravity moves. In addition, in this arrangement, since the two movable legs 120 are disposed adjacent to each other in the X direction, the vibration in the X direction can be easily reduced by changing the fixing holding-force of the two movable legs 120 to the floor 2 such that the fixing holding-force of one movable leg 120 to the floor 2 and the fixing holding-force of the other movable leg 120 to the floor 2 are exchanged with each other. In addition, in this arrangement, the vibration in the Y direction and the vibration in the Z direction can also be reduced by changing the fixing holding-force of one of the two movable legs 120 to the floor 2 and the fixing holding-force of the other movable leg 120 to the floor 2 in synchronization with each other. Note that in the robot system 1 that includes the moving stand 100-1, it is preferable that the robot system 1 be disposed, with the work position at which the robot arm 10A performs work being located on one side (i.e., upper side in FIG. 9A) in the Y direction. With this arrangement, the vibration in the X direction caused by the movement of the robot arm 10A in the X direction can be easily suppressed.

FIG. 9B illustrates a moving stand 100-2 that has an arrangement pattern of the fixed legs 110 and the movable legs 120, as a second pattern. The second pattern is an arrangement pattern in which a single movable leg 120 is added to the first pattern. That is, three fixed legs 110 are arranged such that one fixed leg 110 is disposed at a center in the X direction, on one side in the Y direction, which is the front-and-back direction of the moving stand 100, and that the other two fixed legs 110 are disposed in the vicinity of both ends in the X direction, on the other side in the Y direction. In addition, three movable legs 120 are arranged such that two movable legs 120 are disposed in the vicinity of both ends in the X direction, with the fixed leg 110 disposed on the one side in the Y direction being interposed between the two movable legs 120, and that the other one movable leg 120 is disposed at or near a center in the X direction, between the two fixed legs 110 disposed on the other side in the Y direction. Thus, the three movable legs 120 are disposed outside a FIG. 900-2 formed by connecting the three fixed legs 110 with a line. In the arrangement pattern that is the second pattern, a FIG. 901-2 whose outer edge is formed by the three fixed legs 110 and the three movable legs 120 has its area which is larger than the area of the above-described FIG. 901-1, and in which the robot system 1 can be prevented from falling over even if the center G of gravity moves. In addition, in this arrangement, since the three movable legs 120 are disposed, in a triangle, adjacent to each other in the X direction and the Y direction, the vibration in the X direction and the Y direction can be easily reduced by changing the fixing holding-force of the three movable legs 120 to the floor 2 such that the fixing holding-force of one movable leg 120 to the floor 2 and the fixing holding-force of another movable leg 120 to the floor 2 are exchanged with each other. In addition, in this arrangement, the vibration in the Z direction can also be reduced by changing the fixing holding-force of the three movable legs 120 to the floor 2 in synchronization with each other. Note that in the robot system 1 that includes the moving stand 100-2, the vibration suppression effect can be produced whichever direction the work position at which the robot arm 10A performs work is located in.

Note that in the configuration that includes three or more fixed legs 110 and two or more movable legs 120 as in the arrangement pattern of the fixed legs 110 and the movable legs 120 that is the first pattern illustrated in FIG. 9A or the second pattern illustrated in FIG. 9B, the following arrangement is preferable. That is, it is preferable that the installation portion (or the robot arm 10A) be disposed inside the FIG. 900 formed by connecting the three or more fixed legs 110, which serve as apexes, with a line, and that the two or more movable legs 120 be disposed outside the FIG. 900. This arrangement can easily prevent the robot system 1 from falling over and produce the vibration suppression effect.

FIG. 9C illustrates a moving stand 100-3 that has an arrangement pattern of the fixed legs 110 and the movable legs 120, as a third pattern. The third pattern is an arrangement pattern in which two fixed legs 110 and a single movable leg 120 are disposed. That is, the single movable leg 120 is disposed at or near a center in the X direction, on one side in the Y direction, and the two fixed legs 110 are disposed in the vicinity of both ends in the X direction, on the other side in the Y direction. Thus, a FIG. 900-3 formed by connecting the single movable leg 120 and the two fixed legs 110 with a line is a figure whose outer edge is formed by the single movable leg 120 and the two fixed legs 110. In addition, the area of the FIG. 900-3 is an area in which the robot system 1 can be prevented from falling over even if the center G of gravity moves. In addition, in this arrangement, since the single movable leg 120 is disposed on the one side in the Y direction, the vibration in the Y direction and the Z direction can be easily reduced. Note that in the robot system 1 that includes the moving stand 100-3, it is preferable that the robot system 1 be disposed, with the work position at which the robot arm 10A performs work being located on one side (i.e., upper side in FIG. 9C) in the Y direction. With this arrangement, the vibration in the Y direction caused by the movement of the robot arm 10A in the Y direction can be easily suppressed.

FIG. 9D illustrates a moving stand 100-4 that has an arrangement pattern of the fixed legs 110 and the movable legs 120, as a fourth pattern. The fourth pattern is an arrangement pattern in which a single fixed leg 110 and two movable legs 120 are disposed. That is, the single fixed leg 110 is disposed at or near a center in the X direction, on one side in the Y direction, and the two movable legs 120 are disposed in the vicinity of both ends in the X direction, on the other side in the Y direction. Thus, a FIG. 900-4 formed by connecting the two movable legs 120 and the single fixed leg 110 with a line is a figure whose outer edge is formed by the two movable legs 120 and the single fixed leg 110. In addition, the area of the FIG. 900-4 is an area in which the robot system 1 can be prevented from falling over even if the center G of gravity moves. In addition, in this arrangement, since the two movable legs 120 are disposed on the other side in the Y direction, the vibration in the X direction can be easily reduced by changing the fixing holding-force of the two movable legs 120 to the floor 2 such that the fixing holding-force of one movable leg 120 to the floor 2 and the fixing holding-force of the other movable leg 120 to the floor 2 are exchanged with each other. In addition, in this arrangement, the vibration in the Y direction and the vibration in the Z direction can also be reduced by changing the fixing holding-force of one of the two movable legs 120 to the floor 2 and the fixing holding-force of the other movable leg 120 to the floor 2 in synchronization with each other. Note that in the robot system 1 that includes the moving stand 100-4, it is preferable that the robot system 1 be disposed, with the work position at which the robot arm 10A performs work being located on the other side (i.e., lower side in FIG. 9D) in the Y direction. With this arrangement, the vibration in the X direction caused by the movement of the robot arm 10A in the X direction can be easily suppressed.

FIG. 9E illustrates a moving stand 100-5 that has an arrangement pattern of the fixed legs 110 and the movable legs 120, as a fifth pattern. The fifth pattern is an arrangement pattern in which two fixed legs 110 and two movable legs 120 are disposed. That is, the two movable leg 120 are disposed in the vicinity of both ends in the X direction, on one side in the Y direction, and the two fixed legs 110 are disposed in the vicinity of both ends in the X direction, on the other side in the Y direction. Thus, a FIG. 900-5 formed by connecting the two movable legs 120 and the two fixed legs 110 with a line is a figure whose outer edge is formed by the two movable legs 120 and the two fixed legs 110. In addition, the area of the FIG. 900-5 is an area in which the robot system 1 can be prevented from falling over even if the center G of gravity moves. In addition, in this arrangement, since the two movable legs 120 are disposed on the one side in the Y direction, the vibration in the X direction can be easily reduced by changing the fixing holding-force of the two movable legs 120 to the floor 2 such that the fixing holding-force of one movable leg 120 to the floor 2 and the fixing holding-force of the other movable leg 120 to the floor 2 are exchanged with each other. In addition, in this arrangement, the vibration in the Y direction and the vibration in the Z direction can also be reduced by changing the fixing holding-force of one of the two movable legs 120 to the floor 2 and the fixing holding-force of the other movable leg 120 to the floor 2 in synchronization with each other. Note that in the robot system 1 that includes the moving stand 100-5, it is preferable that the robot system 1 be disposed, with the work position at which the robot arm 10A performs work being located on one side (i.e., upper side in FIG. 9E) in the Y direction. With this arrangement, the vibration in the X direction caused by the movement of the robot arm 10A in the X direction can be easily suppressed.

FIG. 9F illustrates a moving stand 100-6 that has an arrangement pattern of the fixed legs 110 and the movable legs 120, as a sixth pattern. The sixth pattern is an arrangement pattern in which two fixed legs 110 and two movable legs 120 are disposed. That is, one of the two movable legs 120 is disposed at or near a center in the X direction, on one side in the Y direction, and the other movable leg 120 is disposed at or near a center in the X direction, on the other side in the Y direction. In addition, the two fixed legs 110 are disposed in the vicinity of both ends in the X direction, at or near a center in the Y direction. Thus, a FIG. 901-6 formed by connecting the two movable legs 120 and the two fixed legs 110 with a line is a figure whose outer edge is formed by the two movable legs 120 and the two fixed legs 110. In addition, the area of the FIG. 901-6 is an area in which the robot system 1 can be prevented from falling over even if the center G of gravity moves. In addition, in this arrangement, since one of the two movable legs 120 is disposed on the one side in the Y direction and the other movable leg 120 is disposed on the other side in the Y direction, the vibration in the Y direction can be easily reduced by changing the fixing holding-force of the two movable legs 120 to the floor 2 such that the fixing holding-force of one movable leg 120 to the floor 2 and the fixing holding-force of the other movable leg 120 to the floor 2 are exchanged with each other. In addition, in this arrangement, the vibration in the Z direction can also be reduced by changing the fixing holding-force of the two movable legs 120 to the floor 2 in synchronization with each other. Note that in the robot system 1 that includes the moving stand 100-6, it is preferable that the robot system 1 be disposed, with the work position at which the robot arm 10A performs work being located on one side (i.e., a right side or a left side in FIG. 9F) in the X direction. With this arrangement, the vibration in the Y direction caused by the movement of the robot arm 10A in the Y direction can be easily suppressed.

### Posture Control of First Embodiment

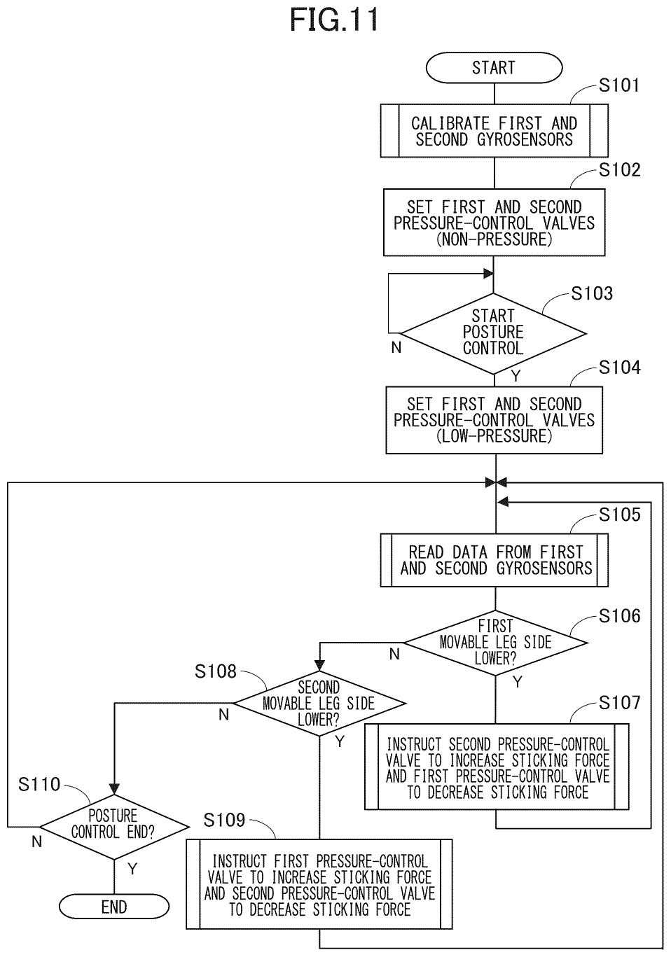

Next, posture control that controls the posture of the moving stand 100 of the first embodiment will be described with reference to FIGS. 10 and 11. FIG. 10A is a diagram illustrating positions in which fixed legs, movable legs, and gyrosensors of the first embodiment are disposed. FIG. 10B is a block diagram illustrating a configuration of a first movable leg and a second movable leg of the first embodiment. FIG. 10C is a block diagram illustrating a control system of the movable legs of the first embodiment. FIG. 11 is a flowchart illustrating the posture control of the first embodiment.

### Configuration for Controlling Moving Stand

First, a configuration of the moving stand 100 for executing the posture control of the first embodiment, and a configuration of each of the first movable leg 120A and the second movable leg 120B included in the moving stand 100 will be described. As illustrated in FIG. 10A, in the moving stand 100-1 (hereinafter simply referred to as the moving stand 100), two movable legs 120 and three fixed legs 110 are disposed in the above-described arrangement pattern that is the first pattern. Note that for distinguishing the two movable legs 120 from each other, one of the two movable legs 120 is referred to as a first movable leg 120A and the other movable leg 120 is referred to as a second movable leg 120B.

In an upper portion of the moving stand 100, a first gyrosensor 600A and a second gyrosensor 600B are disposed as detection portions that detect the state of the moving stand 100 that changes in accordance with the position and posture of the robot arm. Specifically, the first gyrosensor 600A is disposed in the vicinity of the first movable leg 120A when viewed from the up-and-down direction, and the second gyrosensor 600B is disposed in the vicinity of the second movable leg 120B when viewed from the up-and-down direction. Each of the first gyrosensor 600A and the second gyrosensor 600B detects the angular velocity produced by the tilt of the moving stand 100 caused by the vibration of the moving stand 100, and outputs the angular velocity data to the above-described robot controller 200.

As illustrated in FIG. 10B, the first movable leg 120A includes a first pressure-control valve 126A that serves as the above-described pressure control valve, and a first suction cup 127A whose air pressure is adjusted by the first pressure-control valve 126A (see FIG. 5). The first pressure-control valve 126A communicates with a first regulator 800A via the air joint 125a (see FIG. 5). The first regulator 800A is a pressure regulator disposed in the moving stand 100. That is, the negative pressure is produced by the first regulator 800A, and the pressure is adjusted by the first pressure-control valve 126A. As a result, the air in the first suction cup 127A is adjusted, and the sticking force between the first movable leg 120A and the floor 2 is adjusted. That is, the fixing holding-force is changed.

Similarly, the second movable leg 120B includes a second pressure-control valve 126B, and a second suction cup 127B whose air pressure is adjusted by the second pressure-control valve 126B. The second pressure-control valve 126B communicates with a second regulator 800B. That is, the negative pressure is produced by the second regulator 800B, and the pressure is adjusted by the second pressure-control valve 126B. As a result, the air in the second suction cup 127B is adjusted, and the sticking force between the second movable leg 120B and the floor 2 is adjusted. That is, the fixing holding-force is changed.

As illustrated in FIG. 10C, the first gyrosensor 600A and the second gyrosensor 600B are connected to the CPU 201 of the robot controller 200 so that the first gyrosensor 600A and the second gyrosensor 600B can output the angular velocity data, detected by the gyrosensors, to the CPU 201. In addition, the CPU 201 is connected to the first pressure-control valve 126A of the first movable leg 120A and the second pressure-control valve 126B of the second movable leg 120B so that the CPU 201 can output commands for adjusting the pressure, to the first pressure-control valve 126A and the second pressure-control valve 126B.

### Posture Control

Next, the posture control of the first embodiment will be described. If the casters 191 are lifted as described above, and the fixed legs 110 and the movable legs 120 are merely in contact with the floor 2, the robot system 1 will be merely fixed in the horizontal direction, by only the friction between each leg and the floor 2 that is produced by the weight of the robot system 1. In this state, in the up-and-down direction (i.e., the gravity direction), only the weight of the robot system 1 is applied from each leg to the floor 2. If the robot arm 10A, which has its weight of tens of kilograms, moves in this state, there is a possibility that each leg will float up and separate from the floor 2 due to the movement of the center G of gravity and the inertia. For this reason, the posture control of the first embodiment is performed as described below.

As illustrated in FIG. 11, after the CPU 201 starts the posture control, the CPU 201 performs the calibration of the first gyrosensor 600A and the second gyrosensor 600B (S101). That is, in a state where the robot arm 10A is located in an initial position, the CPU 201 performs the initial setting, determining that the tilt of the moving stand 100 is an initial position. Then the CPU 201 sets the state of the first pressure-control valve 126A and the second pressure-control valve 126B to a non-pressure state (S102). That is, the CPU 201 performs the initial setting of the first pressure-control valve 126A and the second pressure-control valve 126B. Then the CPU 201 waits until the CPU 201 determines the start of the posture control (S103: N). If the CPU 201 determines the start of the actual operation of the posture control, based on the determination of the start of driving the robot arm 10A for example (S103: Y), then the CPU 201 proceeds to Step S104.

After the CPU 201 starts the actual operation of the posture control, the CPU 201 controls the first pressure-control valve 126A and the second pressure-control valve 126B so that the state of the first pressure-control valve 126A and the second pressure-control valve 126B becomes a low pressure state (S104). That is, the CPU 201 starts the sticking of the first suction cup 127A and the second suction cup 127B. Then the CPU 201 reads the values detected by the first gyrosensor 600A and the second gyrosensor 600B (S105), and calculates the tilt (posture) of the moving stand 100. After that, the CPU 201 calculates the height of a portion of the moving stand 100 on the first movable leg 120A side in the X direction, and the height of a portion of the moving stand 100 on the second movable leg 120B side in the X direction, based on the posture calculated by the CPU 201.

Then the CPU 201 determines whether the portion of the moving stand 100 on the first movable leg 120A side is lower, based on the result detected by the first gyrosensor 600A and the second gyrosensor 600B (S106). If the portion of the moving stand 100 on the first movable leg 120A side is not lower (S106: N), then the CPU 201 determines whether the portion of the moving stand 100 on the second movable leg 120B side is lower (S108). If the portion of the moving stand 100 on the second movable leg 120B side is also not lower (S108: N), then the CPU 201 proceeds to Step S110 because the moving stand 100 is not tilted. Then the CPU 201 determines whether to end the posture control (S110). That is, the CPU 201 determines whether the drive (work) of the robot arm 10A is completed, and if the robot arm 10A is being driven, then the CPU 201 determines to continue the posture control (S110: N) and returns to Step S105.

Note that if the distal end of the robot arm 10A is moved, for example, to the first movable leg 120A side in the X direction for causing the robot arm 10A to perform work (see FIG. 8C for example), the portion of the moving stand 100 on the first movable leg 120A side lowers. Thus, the CPU 201 determines that the portion of the moving stand 100 on the first movable leg 120A side has lowered, based on the angular velocity detected by the first gyrosensor 600A and the second gyrosensor 600B (S106: Y). In this case, the CPU 201 instructs the second pressure-control valve 126B to increase the sticking force of the second suction cup 127B, and instructs the first pressure-control valve 126A to decrease the sticking force of the first suction cup 127A (S107) (holding-force changing process). That is, the CPU 201 detects that the position and posture of the robot arm 10A has changed and the center of gravity of the moving stand 100 has moved to the first movable leg 120A side. Thus, the CPU 201 suppresses the tilt of the moving stand 100 by increasing the sticking force (i.e., the fixing holding-force) of the second movable leg 120B, opposite to the first movable leg 120A, to the floor 2, and by decreasing the sticking force (i.e., the fixing holding-force) of the first movable leg 120A to the floor 2. In this manner, it becomes possible to prevent the robot system 1 from falling over.

In addition, if the distal end of the robot arm 10A is moved, for example, to the second movable leg 120B side in the X direction for causing the robot arm 10A to perform work (see FIG. 8B for example), the portion of the moving stand 100 on the second movable leg 120B side lowers. Thus, the CPU 201 determines that the portion of the moving stand 100 on the second movable leg 120B side has lowered, based on the angular velocity detected by the first gyrosensor 600A and the second gyrosensor 600B (S106: N and S108: Y). In this case, the CPU 201 instructs the first pressure-control valve 126A to increase the sticking force of the first suction cup 127A, and instructs the second pressure-control valve 126B to decrease the sticking force of the second suction cup 127B (S109) (holding-force changing process). That is, the CPU 201 detects that the position and posture of the robot arm 10A has changed and the center of gravity of the moving stand 100 has moved to the second movable leg 120B side. Thus, the CPU 201 suppresses the tilt of the moving stand 100 by increasing the sticking force (i.e., the fixing holding-force) of the first movable leg 120A, opposite to the second movable leg 120B, to the floor 2, and by decreasing the sticking force (i.e., the fixing holding-force) of the second movable leg 120B to the floor 2. In this manner, it becomes possible to prevent the robot system 1 from falling over.

Thus, every time the tilt of the moving stand 100 is detected, the CPU 201 suppresses the tilt of the moving stand 100 by controlling the sticking force (i.e., the fixing holding-force) of the first movable leg 120A and the second movable leg 120B to the floor 2. With this operation, the sticking force (i.e., the fixing holding-force) of the first movable leg 120A and the second movable leg 120B to the floor 2 is produced also for the vibration of the moving stand 100 caused by the motion of the robot arm 10A, for suppressing the vibration. Thus, it is possible to suppress the vibration of the moving stand 100, especially in the X direction.

Note that if the CPU 201 determines that the drive (work) of the robot arm 10A is completed, then the CPU 201 determines to end the posture control (S110: Y) and ends the posture control of the present embodiment.

### Summary of First Embodiment

As described above, in the robot system 1 of the first embodiment, in a case where the robot system 1 (or the moving stand 100) is moved, the robot system 1 can be installed by only lifting the casters 191 and causing the fixed legs 110 and the movable legs 120 to contact the floor 2. That is, since the air sticking portion 125 that can change the fixing holding-force to the floor 2 is disposed in the movable leg 120, it is possible to prevent the falling over and vibration of the robot system 1 that are caused by the motion of the robot arm 10A. Thus, the robot system 1 (especially the robot arm 10A) can be stabilized in a place where the robot system 1 is installed, and the need for firmly fixing the robot system 1 to the floor 2 can be eliminated. That is, if the movable legs and the fixed legs are fixed to the floor 2 via a mechanical component such as an anchor, the legs can be fixed firmly to the floor 2, but the vibration cannot be suppressed because the fixing force cannot be changed. Furthermore, the work for fixing the legs to the floor 2 by using a mechanical component such as an anchor takes time in a place to which the robot system 1 has been moved. In the present embodiment, however, in a case where the robot system 1 (or the moving stand 100) is moved, the robot system 1 can be easily installed in a place where the robot system 1 is installed, and the time required for the start of work can be shortened. In addition, since the vibration of the moving stand 100 can be suppressed in this manner, the occurrence of the failure in assembly work of components, assembled in the work performed by the robot system 1, can also be reduced.

In addition, in the robot system 1, in a case where the plurality of legs is brought into contact with the floor after the casters 191 are lifted, the two movable legs 120 are brought into contact with the floor 2 so as to adapt the floor 2, after the three fixed legs 110 are brought into contact with the floor 2 so as to adapt the floor 2. Thus, even if the surface of the floor 2 is uneven, the plurality of legs can be brought into contact with the floor 2 so as to adapt the floor 2. As a result, the moving stand 100 can be installed stably.

In addition, in the robot system 1, since the two movable legs 120 are disposed outside the FIG. 900 formed by connecting the three fixed legs 110 with a line, the area in which the center G of gravity is supported by the movable legs when the center G of gravity is moved can be made larger. As a result, it becomes possible to prevent the robot system 1 from falling over and suppress the tilt of the moving stand 100. In addition, in the robot system 1, each of the two movable legs 120 includes the air sticking portion 125, and the sticking force (i.e., the fixing holding-force) to the floor 2 can be changed. In this case, since the posture control is performed for controlling the magnitude of the fixing holding-force of the air sticking portion 125 in accordance with the result detected by the first gyrosensor 600A and the second gyrosensor 600B, the posture of the moving stand 100 can be stabilized and the vibration can be suppressed.

Note that the floor 2 on which the robot system 1 is installed may be vibrated by another machine tool or robot system. In this case, the floor 2 may be vibrated at a high frequency of 10 Hz or more, while vibrated, for example, at a frequency of about 1 to 10 Hz by the motion of the robot arm 10A. In the present embodiment, such vibration of the floor 2 can also be detected by the first gyrosensor 600A and the second gyrosensor 600B, via the fixed legs 110 and the movable legs 120. Thus, the vibration of the floor 2 transmitted to the robot arm 10A can also be reduced by performing the above-described posture control. Note that for making it difficult for the vibration of the floor 2 to transmit to the robot arm 10A, a vibration-isolating mechanism, a vibration-removing mechanism, or a vibration-damping mechanism may be disposed between the installation portion of the moving stand 100 and the robot arm 10A. Such a vibration-isolating mechanism, vibration-removing mechanism, or vibration-damping mechanism may be a mechanism in which a gel-like vibration-isolating sheet or the like is interposed.

### Second Embodiment

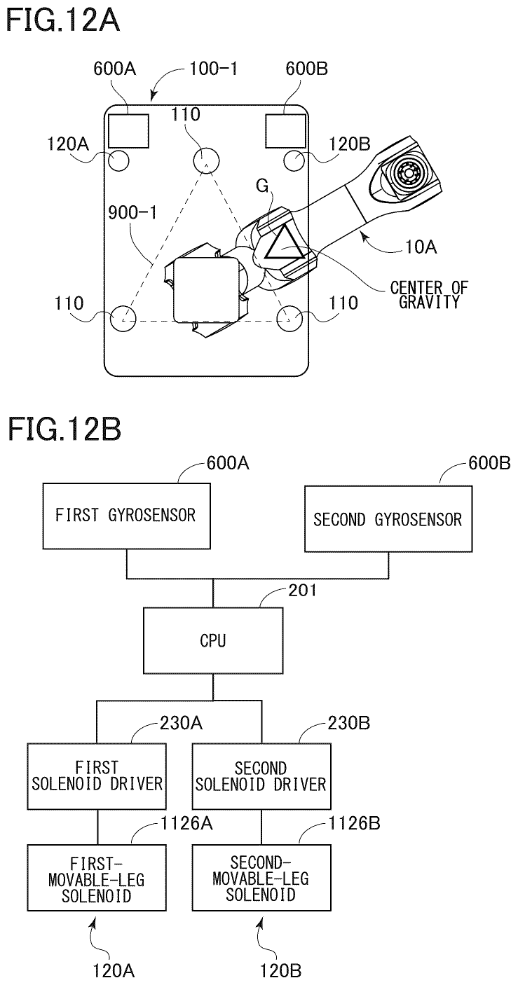

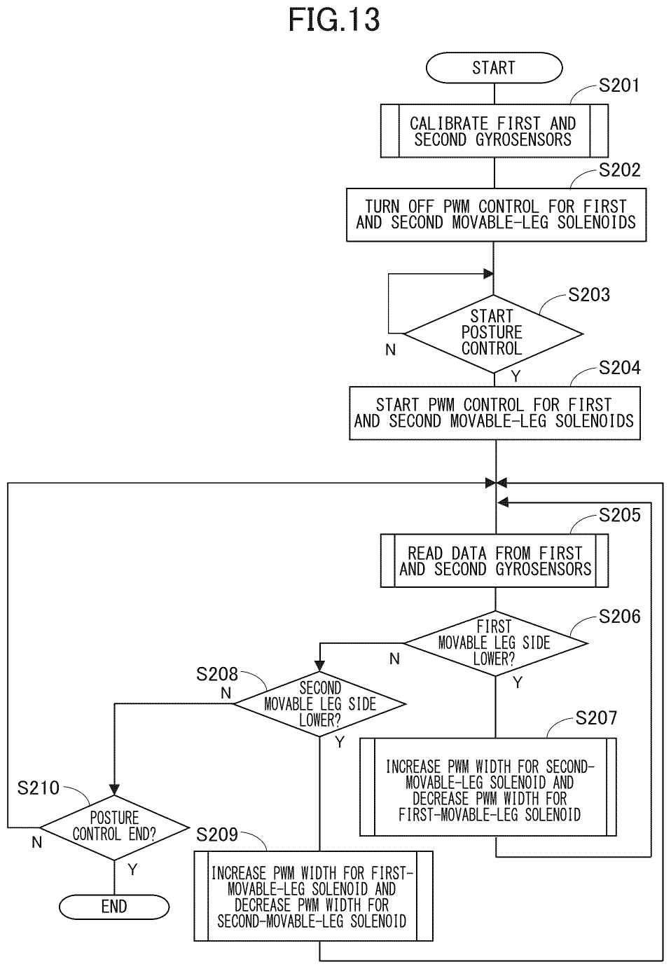

Next, a second embodiment will be described with reference to FIGS. 12 and 13. In the second embodiment, part of the above-described first embodiment is changed. FIG. 12A is a diagram illustrating positions in which fixed legs, movable legs, and gyrosensors of the second embodiment are disposed. FIG. 12B is a block diagram illustrating a control system of the movable legs of the second embodiment. FIG. 13 is a flowchart illustrating the posture control of the second embodiment.

In the second embodiment, a solenoid that serves as a magnetic-force sticking portion is used instead of the air sticking portion 125 of the above-described first embodiment, and the fixing holding-force of the movable leg 120 is changed by changing the magnetic force generated by the solenoid and causing the movable leg 120 and the floor 2 to magnetically stick to each other. Note that in the second embodiment, the floor 2 is made of a magnetic material, and the floor 2 and the movable leg 120 are caused to magnetically stick to each other, by the magnetic force. Hereinafter, a configuration for control and posture control of the second embodiment will be described.

### Configuration for Controlling Moving Stand

First, a configuration of a moving stand 100 for executing the posture control of the second embodiment, and a configuration of each of a first movable leg 120A and a second movable leg 120B included in the moving stand 100 will be described. As illustrated in FIG. 12A, in a moving stand 100-1 (hereinafter simply referred to as the moving stand 100), two movable legs 120 and three fixed legs 110 are disposed in the above-described arrangement pattern that is the first pattern, as in the first embodiment. Note that for distinguishing the two movable legs 120 from each other, one of the two movable legs 120 is referred to as a first movable leg 120A and the other movable leg 120 is referred to as a second movable leg 120B.

As in the first embodiment, in an upper portion of the moving stand 100, a first gyrosensor 600A and a second gyrosensor 600B are disposed. Specifically, the first gyrosensor 600A is disposed in the vicinity of the first movable leg 120A when viewed from the up-and-down direction, and the second gyrosensor 600B is disposed in the vicinity of the second movable leg 120B when viewed from the up-and-down direction. Each of the first gyrosensor 600A and the second gyrosensor 600B detects the angular velocity produced by the tilt of the moving stand 100 caused by the vibration of the moving stand 100, and outputs the angular velocity data to the above-described robot controller 200.

As illustrated in FIG. 12B, the first movable leg 120A includes a first-movable-leg solenoid 1126A that serves as a magnetic-force sticking portion or a holding-force changing portion, and that includes a coil (not illustrated) that generates magnetic force. Similarly, the second movable leg 120B includes a second-movable-leg solenoid 1126B that serves as a magnetic-force sticking portion or a holding-force changing portion, and that includes a coil (not illustrated) that generates magnetic force. In addition, the moving stand 100 accommodates a first solenoid driver 230A that controls the electric power applied to the first-movable-leg solenoid 1126A, and a second solenoid driver 230B that controls the electric power applied to the second-movable-leg solenoid 1126B. Since these solenoid drivers are commonly used driving circuits, the description thereof will be omitted.

As in the first embodiment, the first gyrosensor 600A and the second gyrosensor 600B are connected to the CPU 201 of the robot controller 200 so that the first gyrosensor 600A and the second gyrosensor 600B can output the angular velocity data, detected by the gyrosensors, to the CPU 201. In addition, the CPU 201 is connected to the first solenoid driver 230A and the second solenoid driver 230B so that the CPU 201 can output PWM-control instruction signals (i.e., pulse-width signals) to the solenoid drivers.

In the first movable leg 120A and the second movable leg 120B, the first-movable-leg solenoid 1126A or the second-movable-leg solenoid 1126B is driven by the CPU 201 instructing the first solenoid driver 230A or the second solenoid driver 230B. As a result, the magnetic force of the first movable leg 120A or the second movable leg 120B is changed, so that the magnetic sticking force between the first movable leg 120A or the second movable leg 120B and the floor 2 is changed, changing the fixing holding-force of the first movable leg 120A or the second movable leg 120B.

### Posture Control

As illustrated in FIG. 13, after the CPU 201 starts the posture control, the CPU 201 performs the calibration of the first gyrosensor 600A and the second gyrosensor 600B (S201). That is, in a state where the robot arm 10A is located in an initial position, the CPU 201 performs the initial setting, determining that the tilt of the moving stand 100 is an initial position. Then the CPU 201 turns the PWM control OFF (S202) (the PWM control is performed on the first-movable-leg solenoid 1126A and the second-movable-leg solenoid 1126B). That is, the CPU 201 performs the initial setting of the first-movable-leg solenoid 1126A and the second-movable-leg solenoid 1126B. Then the CPU 201 waits until the CPU 201 determines the start of the posture control (S203: N). If the CPU 201 determines the start of the actual operation of the posture control, based on the determination of the start of driving the robot arm 10A for example (S203: Y), then the CPU 201 proceeds to Step S204.

After the CPU 201 starts the actual operation of the posture control, the CPU 201 starts the PWM control of the first-movable-leg solenoid 1126A and the second-movable-leg solenoid 1126B (S204). That is, the CPU 201 allows the first-movable-leg solenoid 1126A and the second-movable-leg solenoid 1126B to generate magnetic force. Then the CPU 201 reads the values detected by the first gyrosensor 600A and the second gyrosensor 600B (S205), and calculates the tilt (posture) of the moving stand 100. After that, the CPU 201 calculates the height of a portion of the moving stand 100 on the first movable leg 120A side in the X direction, and the height of a portion of the moving stand 100 on the second movable leg 120B side in the X direction, based on the posture calculated by the CPU 201.

Then the CPU 201 determines whether the portion of the moving stand 100 on the first movable leg 120A side is lower, based on the result detected by the first gyrosensor 600A and the second gyrosensor 600B (S206). If the portion of the moving stand 100 on the first movable leg 120A side is not lower (S206: N), then the CPU 201 determines whether the portion of the moving stand 100 on the second movable leg 120B side is lower (S208). If the portion of the moving stand 100 on the second movable leg 120B side is also not lower (S208: N), then the CPU 201 proceeds to Step S210 because the moving stand 100 is not tilted. Then the CPU 201 determines whether to end the posture control (S210). That is, the CPU 201 determines whether the drive (work) of the robot arm 10A is completed, and if the robot arm 10A is being driven, then the CPU 201 determines to continue the posture control (S210: N) and returns to Step S205.

Note that if the distal end of the robot arm 10A is moved, for example, to the first movable leg 120A side in the X direction for causing the robot arm 10A to perform work (see FIG. 8C for example), the portion of the moving stand 100 on the first movable leg 120A side lowers. Thus, the CPU 201 determines that the portion of the moving stand 100 on the first movable leg 120A side has lowered, based on the angular velocity detected by the first gyrosensor 600A and the second gyrosensor 600B (S206: Y). In this case, the CPU 201 performs the instruction for increasing the magnetic sticking force of the second movable leg 120B, by increasing the pulse width of the PWM control performed on the second-movable-leg solenoid 1126B. In addition, the CPU 201 performs the instruction for decreasing the magnetic sticking force of the first movable leg 120A, by decreasing the pulse width of the PWM control performed on the first-movable-leg solenoid 1126A (S207) (holding-force changing process). That is, the CPU 201 detects that the position and posture of the robot arm 10A has changed and the center of gravity of the moving stand 100 has moved to the first movable leg 120A side. Thus, the CPU 201 suppresses the tilt of the moving stand 100 by increasing the magnetic sticking force (i.e., the fixing holding-force) of the second movable leg 120B, opposite to the first movable leg 120A, to the floor 2, and by decreasing the magnetic sticking force (i.e., the fixing holding-force) of the first movable leg 120A to the floor 2. In this manner, it becomes possible to prevent the robot system 1 from falling over.

In addition, if the distal end of the robot arm 10A is moved, for example, to the second movable leg 120B side in the X direction for causing the robot arm 10A to perform work (see FIG. 8B for example), the portion of the moving stand 100 on the second movable leg 120B side lowers. Thus, the CPU 201 determines that the portion of the moving stand 100 on the second movable leg 120B side has lowered, based on the angular velocity detected by the first gyrosensor 600A and the second gyrosensor 600B (S206: N and S208: Y). In this case, the CPU 201 performs the instruction for increasing the magnetic sticking force of the first movable leg 120A, by increasing the pulse width of the PWM control performed on the first-movable-leg solenoid 1126A. In addition, the CPU 201 performs the instruction for decreasing the magnetic sticking force of the second movable leg 120B, by decreasing the pulse width of the PWM control performed on the second-movable-leg solenoid 1126B (S209) (holding-force changing process). That is, the CPU 201 detects that the position and posture of the robot arm 10A has changed and the center of gravity of the moving stand 100 has moved to the second movable leg 120B side. Thus, the CPU 201 suppresses the tilt of the moving stand 100 by increasing the magnetic sticking force (i.e., the fixing holding-force) of the first movable leg 120A, opposite to the second movable leg 120B, to the floor 2, and by decreasing the magnetic sticking force (i.e., the fixing holding-force) of the second movable leg 120B to the floor 2. In this manner, it becomes possible to prevent the robot system 1 from falling over.

Thus, every time the tilt of the moving stand 100 is detected, the CPU 201 suppresses the tilt of the moving stand 100 by controlling the magnetic sticking force (i.e., the fixing holding-force) of the first movable leg 120A and the second movable leg 120B to the floor 2. With this operation, the magnetic sticking force (i.e., the fixing holding-force) of the first movable leg 120A and the second movable leg 120B to the floor 2 is produced also for the vibration of the moving stand 100 caused by the motion of the robot arm 10A, for suppressing the vibration. Thus, it is possible to suppress the vibration of the moving stand 100, especially in the X direction.

Note that if the CPU 201 determines that the drive (work) of the robot arm 10A is completed, then the CPU 201 determines to end the posture control (S210: Y) and ends the posture control of the present embodiment.

### Summary of Second Embodiment

As described above, also in the robot system 1 of the second embodiment, in a case where the robot system 1 (or the moving stand 100) is moved, the robot system 1 can be installed by only lifting the casters 191 and causing the fixed legs 110 and the movable legs 120 to contact the floor 2. That is, since the first-movable-leg solenoid 1126A and the second-movable-leg solenoid 1126B that can change the fixing holding-force to the floor 2 are disposed in the movable legs 120, it is possible to prevent the falling over and vibration of the robot system 1 that are caused by the motion of the robot arm 10A. Thus, the robot system 1 (especially the robot arm 10A) can be stabilized in a place where the robot system 1 is installed, and the need for firmly fixing the robot system 1 to the floor 2 can be eliminated. Thus, in a case where the robot system 1 (or the moving stand 100) is moved, the robot system 1 can be easily installed in a place where the robot system 1 is installed, and the time required for the start of work can be shortened.

In addition, in the second embodiment, since the magnetic force generated by the first-movable-leg solenoid 1126A and the second-movable-leg solenoid 1126B can be controlled electrically, the first-movable-leg solenoid 1126A and the second-movable-leg solenoid 1126B have better responsivity than that of the air sticking portion 125 of the first embodiment. Thus, it becomes possible to more stably prevent the robot system 1 from falling over, suppress the tilt, and suppress the vibration.

Note that since other configurations, operations, and effects of the above-described second embodiment are the same as those of the above-described first embodiment, the description thereof will be omitted.

### Third Embodiment

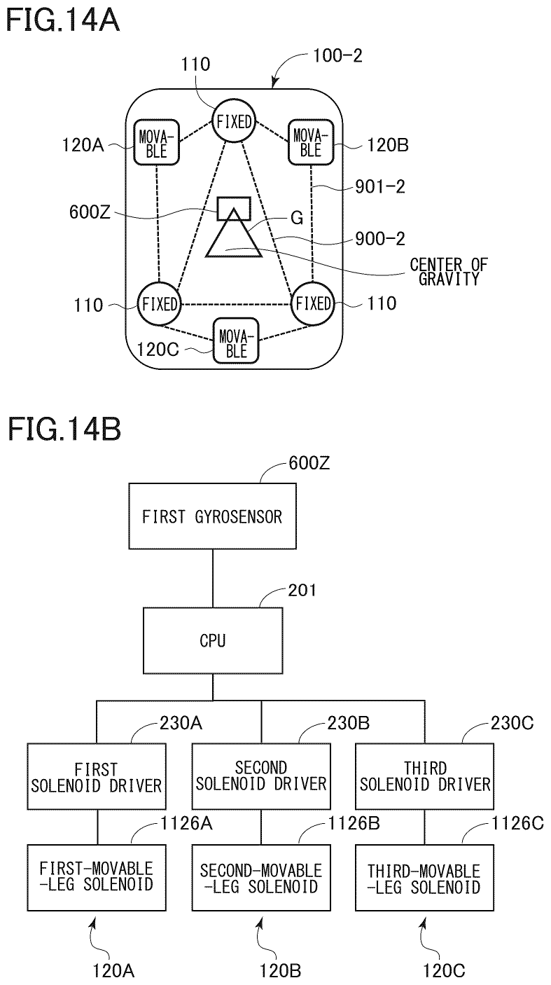

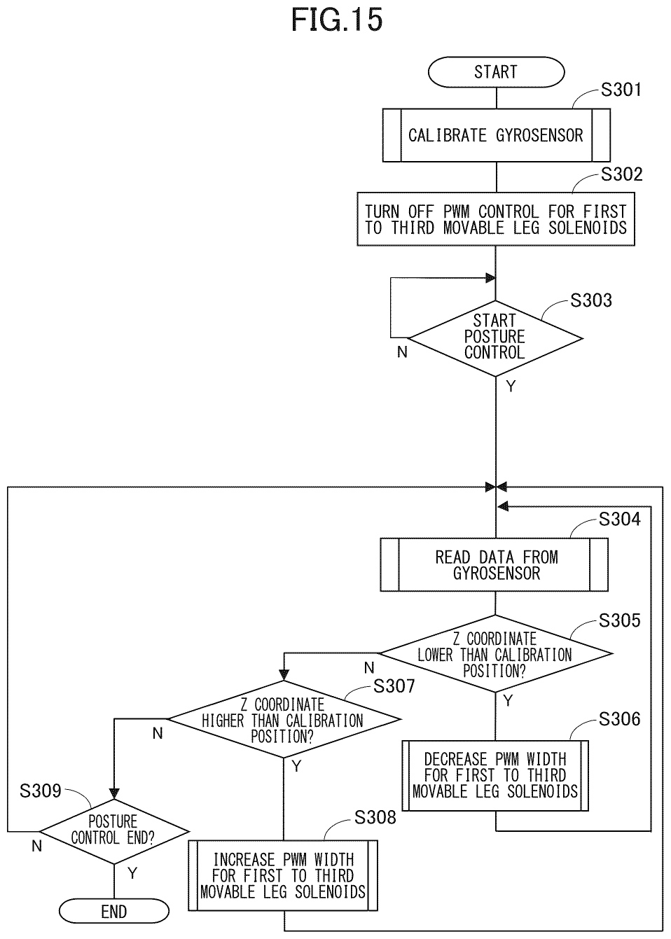

Next, a third embodiment will be described with reference to FIGS. 14 and 15. In the third embodiment, part of the above-described second embodiment is changed. FIG. 14A is a diagram illustrating positions in which fixed legs, movable legs, and a gyrosensor of the third embodiment are disposed. FIG. 14B is a block diagram illustrating a control system of the movable legs of the third embodiment. FIG. 15 is a flowchart illustrating the posture control of the third embodiment.

Unlike in the above-described second embodiment, in the third embodiment, the moving stand 100 includes three movable legs 120, each including the solenoid that serves as a magnetic-force sticking portion. In addition, the fixing holding-force of the movable leg 120 is changed by changing the magnetic force generated by the solenoid and causing the movable leg 120 and the floor 2 to magnetically stick to each other, so that the vibration of the moving stand 100 in the up-and-down direction is suppressed. Note that also in the third embodiment, the floor 2 is made of a magnetic material, and the floor 2 and the movable leg 120 are caused to magnetically stick to each other, by the magnetic force. Hereinafter, a configuration for control and posture control of the third embodiment will be described.

### Configuration for Controlling Moving Stand

First, a configuration of a moving stand 100 for executing the posture control of the third embodiment, and a configuration of a first movable leg 120A, a second movable leg 120B, and a third movable leg 120C included in the moving stand 100 will be described. As illustrated in FIG. 14A, in a moving stand 100-2 (hereinafter simply referred to as the moving stand 100), three movable legs 120 and three fixed legs 110 are disposed in the above-described arrangement pattern that is the second pattern (see FIG. 9B). Note that for distinguishing the three movable legs 120 from each other, the three movable legs 120 are referred to as the first movable leg 120A, the second movable leg 120B, and the third movable leg 120C.

In an upper portion of the moving stand 100, a single gyrosensor 600Z is disposed at or near a center in the X direction and the Y direction. The gyrosensor 600Z detects the angular velocity produced by the vibration of the moving stand 100 in the up-and-down direction, and outputs the angular velocity data to the above-described robot controller 200.

As illustrated in FIG. 14B, the first movable leg 120A includes a first-movable-leg solenoid 1126A that serves as a magnetic-force sticking portion, and that includes a coil (not illustrated) that generates magnetic force. Similarly, the second movable leg 120B includes a second-movable-leg solenoid 1126B that serves as a magnetic-force sticking portion, and that includes a coil (not illustrated) that generates magnetic force. Similarly, the third movable leg 120C includes a third-movable-leg solenoid 1126C that serves as a magnetic-force sticking portion, and that includes a coil (not illustrated) that generates magnetic force. In addition, the moving stand 100 accommodates a first solenoid driver 230A that controls the electric power applied to the first-movable-leg solenoid 1126A. Similarly, the moving stand 100 accommodates a second solenoid driver 230B that controls the electric power applied to the second-movable-leg solenoid 1126B. Similarly, the moving stand 100 accommodates a third solenoid driver 230C that controls the electric power applied to the third-movable-leg solenoid 1126C. Since these solenoid drivers are commonly used driving circuits, the description thereof will be omitted.

The gyrosensor 600Z is connected to the CPU 201 of the robot controller 200 so that the gyrosensor 600Z can output the angular velocity data, detected by the gyrosensor 600Z, to the CPU 201. In addition, the CPU 201 is connected to the first solenoid driver 230A, the second solenoid driver 230B, and the third solenoid driver 230C so that the CPU 201 can output PWM-control instruction signals (i.e., pulse-width signals) to the solenoid drivers.

In the first movable leg 120A, the second movable leg 120B, and the third movable leg 120C, the first solenoid driver 230A, the second solenoid driver 230B, or the third solenoid driver 230C is instructed by the CPU 201. As a result, the first-movable-leg solenoid 1126A, the second-movable-leg solenoid 1126B, or the third-movable-leg solenoid 1126C is driven, so that the magnetic force of the first movable leg 120A, the second movable leg 120B, or the third movable leg 120C is changed. Thus, the magnetic sticking force between the movable leg 120 and the floor 2 is changed, so that the fixing holding-force of the movable leg 120 is changed.

### Posture Control

As illustrated in FIG. 15, after the CPU 201 starts the posture control (which serves also as vibration suppression control in the third embodiment), the CPU 201 performs the calibration of the gyrosensor 600Z (S301). That is, in a state where the robot arm 10A is located in an initial position, the CPU 201 performs the initial setting, determining that the tilt of the moving stand 100 is an initial position. Then the CPU 201 turns the PWM control OFF (S302) (the PWM control is performed on the first-movable-leg solenoid 1126A, the second-movable-leg solenoid 1126B, and the third-movable-leg solenoid 1126C). That is, the CPU 201 performs the initial setting of the first-movable-leg solenoid 1126A, the second-movable-leg solenoid 1126B, and the third-movable-leg solenoid 1126C. Then the CPU 201 waits until the CPU 201 determines the start of the posture control (S303: N). If the CPU 201 determines the start of the actual operation of the posture control, based on the determination of the start of driving the robot arm 10A for example (S303: Y), then the CPU 201 proceeds to Step S304.

After the CPU 201 starts the actual operation of the posture control, the CPU 201 reads the value detected by the gyrosensor 600Z (S304), and calculates a Z coordinate (i.e., a position in the up-and-down direction) of the moving stand 100.

Then the CPU 201 determines in S305, depending on the result detected by the gyrosensor 600Z, whether the position of the whole of the moving stand 100 is lower than the position (i.e., the Z coordinate) of the moving stand 100 obtained in the calibration, that is, in the initial setting performed in the above-described Step S301. If the moving stand 100 is not lower than the position (S305: N), then the CPU 201 determines whether the moving stand 100 is higher than the position (S307). If the moving stand 100 is not higher than the position (S307: N), then the CPU 201 proceeds to Step S309 because the moving stand 100 is not moving in the up-and-down direction. Then the CPU 201 determines whether to end the posture control (S309). That is, the CPU 201 determines whether the drive (work) of the robot arm 10A is completed, and if the robot arm 10A is being driven, then the CPU 201 determines to continue the posture control (S309: N) and returns to Step S304.

If the robot arm 10A is driven, for example, for performing work and the whole of the moving stand 100 has lowered, then the CPU 201 determines that the moving stand 100 has lowered, based on the angular velocity detected by the gyrosensor 600Z (S305: Y). In this case, the CPU 201 performs the instruction for decreasing the magnetic sticking force of the first movable leg 120A, the second movable leg 120B, and the third movable leg 120C, by decreasing the pulse width of the PWM control performed on the first-movable-leg solenoid 1126A, the second-movable-leg solenoid 1126B, and the third-movable-leg solenoid 1126C (S306) (holding-force changing process). That is, the CPU 201 detects that the position and posture of the robot arm 10A has changed and the moving stand 100 has moved downward. Thus, for moving the moving stand 100 toward the opposite direction, the CPU 201 decreases the force that moves the moving stand 100 toward the downward direction, by decreasing the magnetic sticking force of the first movable leg 120A, the second movable leg 120B, and the third movable leg 120C. In this manner, it becomes possible to prevent the robot system 1 from moving downward.

If the robot arm 10A is driven, for example, for performing work and the whole of the moving stand 100 has moved up, the CPU 201 determines that the moving stand 100 has moved up, based on the angular velocity detected by the gyrosensor 600Z (S307: Y). In this case, the CPU 201 performs the instruction for increasing the magnetic sticking force of the first movable leg 120A, the second movable leg 120B, and the third movable leg 120C, by increasing the pulse width of the PWM control performed on the first-movable-leg solenoid 1126A, the second-movable-leg solenoid 1126B, and the third-movable-leg solenoid 1126C (S308) (holding-force changing process). That is, the CPU 201 detects that the position and posture of the robot arm 10A has changed and the moving stand 100 has moved upward. Thus, for moving the moving stand 100 toward the opposite direction, the CPU 201 decreases the force that moves the moving stand 100 toward the upward direction, by increasing the magnetic sticking force of the first movable leg 120A, the second movable leg 120B, and the third movable leg 120C. In this manner, it becomes possible to prevent the robot system 1 from moving upward.

Thus, every time the movement of the moving stand 100 in the up-and-down direction is detected, the CPU 201 suppresses the movement of the moving stand 100 in the up-and-down direction by controlling the magnetic sticking force (i.e., the fixing holding-force) of the first movable leg 120A, the second movable leg 120B, and the third movable leg 120C to the floor 2. With this operation, the magnetic sticking force (i.e., the fixing holding-force) of the first movable leg 120A, the second movable leg 120B, and the third movable leg 120C to the floor 2 is produced also for the vibration of the moving stand 100, produced in the up-and-down direction and caused by the motion of the robot arm 10A, for suppressing the vibration. Thus, it is possible to suppress the vibration of the moving stand 100, especially in the Z direction.

Note that if the CPU 201 determines that the drive (work) of the robot arm 10A is completed, then the CPU 201 determines to end the posture control (S309: Y) and ends the posture control of the present embodiment.

### Summary of Third Embodiment

As described above, also in the robot system 1 of the third embodiment, in a case where the robot system 1 (or the moving stand 100) is moved, the robot system 1 can be installed by only lifting the casters 191 and causing the fixed legs 110 and the movable legs 120 to contact the floor 2. That is, since the first-movable-leg solenoid 1126A, the second-movable-leg solenoid 1126B, and the third-movable-leg solenoid 1126C that can change the fixing holding-force to the floor 2 are disposed in the movable legs 120, it is possible to suppress the vibration of the robot system 1, which is caused by the motion of the robot arm 10A. Thus, the robot system 1 (especially the robot arm 10A) can be stabilized in a place where the robot system 1 is installed, and the need for firmly fixing the robot system 1 to the floor 2 can be eliminated. Thus, in a case where the robot system 1 (or the moving stand 100) is moved, the robot system 1 can be easily installed in a place where the robot system 1 is installed, and the time required for the start of work can be shortened.

Note that since other configurations, operations, and effects of the above-described third embodiment are the same as those of the above-described second embodiment, the description thereof will be omitted.

### Fourth Embodiment

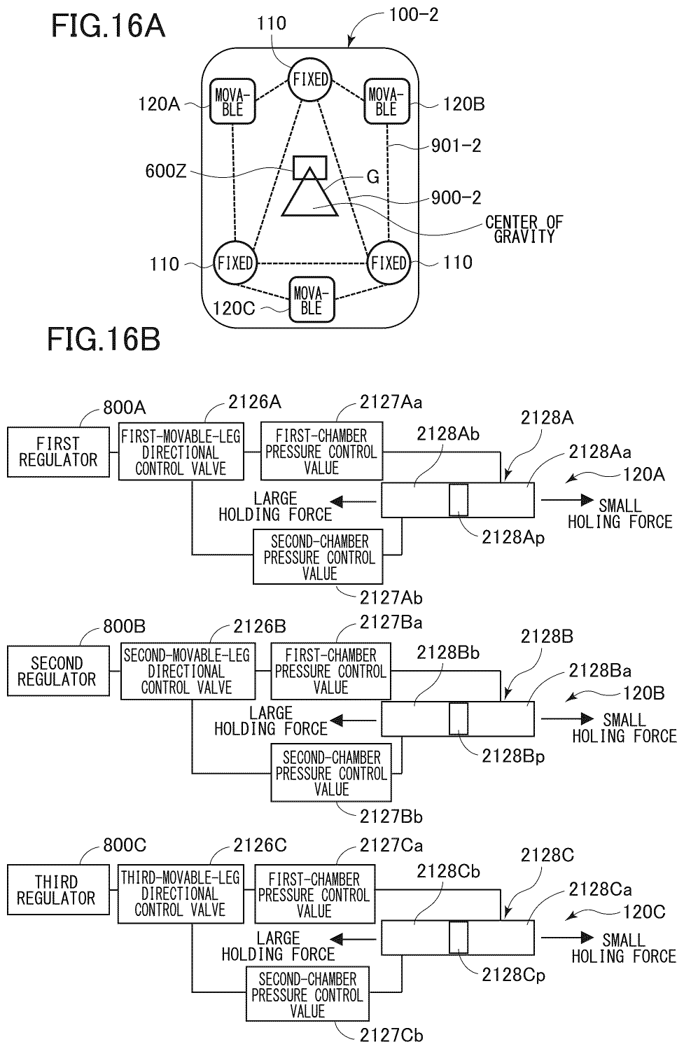

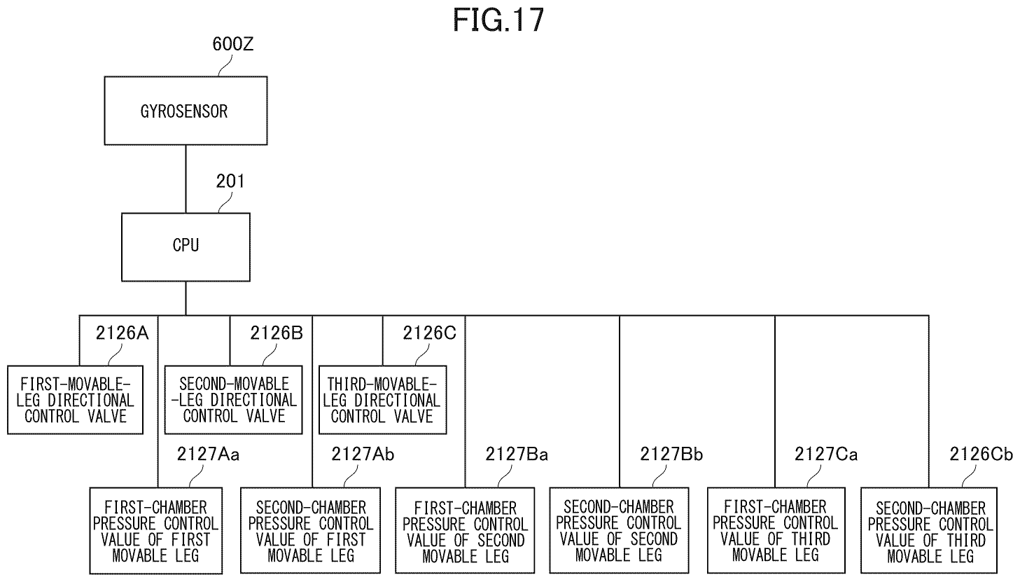

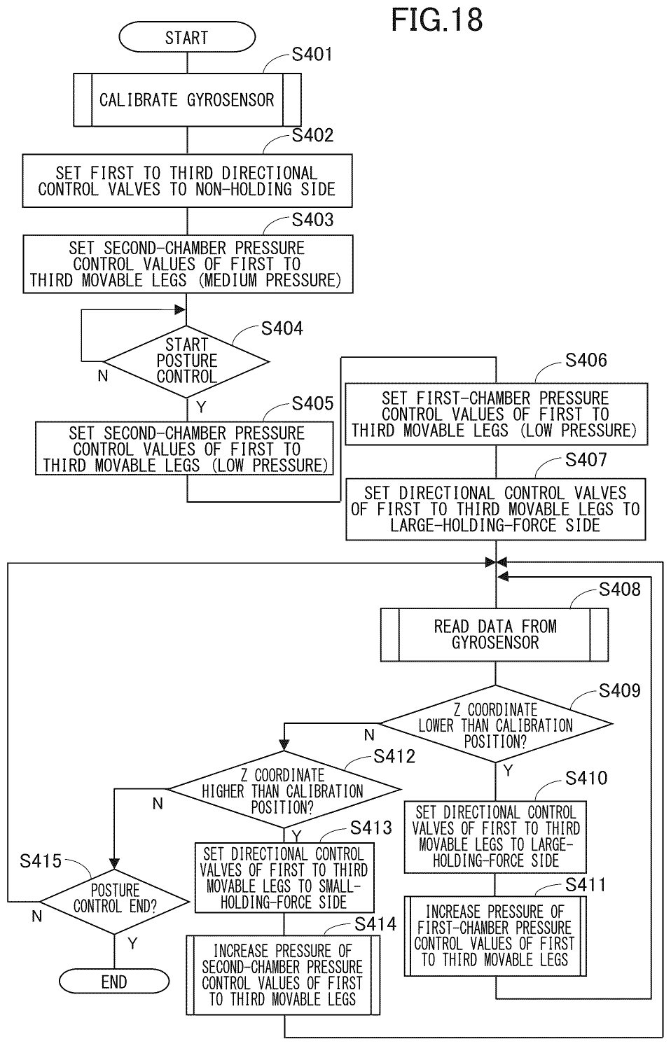

Next, a fourth embodiment will be described with reference to FIGS. 16, 17 and 18. In the fourth embodiment, part of the above-described third embodiment is changed. FIG. 16A is a diagram illustrating positions in which fixed legs, movable legs, and a gyrosensor of the fourth embodiment are disposed. FIG. 16B is a block diagram illustrating a configuration of a first movable leg, a second movable leg, and a third movable leg of the fourth embodiment. FIG. 17 is a block diagram illustrating a control system of the movable legs of the fourth embodiment. FIG. 18 is a flowchart illustrating the posture control of the fourth embodiment.

Unlike in the above-described third embodiment, in the fourth embodiment, the moving stand 100 includes three movable legs 120, each including an air cylinder 2128 that serves as a holding-force changing portion. In addition, the fixing holding-force of the movable leg 120 to the floor 2 is changed by changing the rigidity of the movable legs 120 by using the air cylinder, so that the vibration of the moving stand 100 in the up-and-down direction is suppressed. That is, if the rigidity of the movable leg 120 is increased, the movable leg 120 lowers less when applied with load; if the rigidity of the movable leg 120 is decreased, the movable leg 120 can be prevented from floating up when the load is lightened. In this manner, the fixing holding-force to the floor 2 is changed. In addition, as the total balance of the plurality of legs, even if the moving stand 100 is tilted, the fixing holding-force to the floor 2 can be increased. Hereinafter, a configuration for control and posture control of the fourth embodiment will be described.

### Configuration for Controlling Moving Stand

First, a configuration of a moving stand 100 for executing the posture control of the fourth embodiment, and a configuration of a first movable leg 120A, a second movable leg 120B, and a third movable leg 120C included in the moving stand 100 will be described. As illustrated in FIG. 16A, in a moving stand 100-2 (hereinafter simply referred to as the moving stand 100), three movable legs 120 and three fixed legs 110 are disposed in the above-described arrangement pattern that is the second pattern (see FIG. 9B). Note that for distinguishing the three movable legs 120 from each other, the three movable legs 120 are referred to as the first movable leg 120A, the second movable leg 120B, and the third movable leg 120C.

In an upper portion of the moving stand 100, a single gyrosensor 600Z is disposed, as a detection portion, at or near a center in the X direction and the Y direction. The gyrosensor 600Z detects the angular velocity produced by the vibration of the moving stand 100 in the up-and-down direction, and outputs the angular velocity data to the above-described robot controller 200.

As illustrated in FIG. 16B, the first movable leg 120A includes a first-movable-leg directional control valve 2126A connected to a first regulator 800A and supplied with the air pressure. The first regulator 800A is accommodated in the moving stand 100. In addition, the first movable leg 120A includes a first-chamber pressure control value 2127Aa that adjusts the air pressure supplied from the first-movable-leg directional control valve 2126A and supplies the adjusted air pressure to a first chamber 2128Aa of a first air cylinder 2128A. In addition, the first movable leg 120A includes a second-chamber pressure control value 2127Ab that adjusts the air pressure supplied from the first-movable-leg directional control valve 2126A and supplies the adjusted air pressure to a second chamber 2128Ab of the first air cylinder 2128A. The first air cylinder 2128A includes the first chamber 2128Aa, the second chamber 2128Ab, and a first piston 2128Ap disposed between the first chamber 2128Aa and the second chamber 2128Ab. In addition, a rod (not illustrated) linked with the first piston 2128Ap is linked with a contact portion (not illustrated) of the first movable leg 120A such that the rod can be driven by the contact portion. That is, the first piston 2128Ap causes the first air cylinder 2128A to transmit the load to the floor 2. In the first air cylinder 2128A configured in this manner, the rigidity increases if the pressure of the air of the first chamber 2128Aa and the pressure of the air of the second chamber 2128Ab increase (the air of the first chamber 2128Aa and the air of the second chamber 2128Ab face each other), and decreases if the pressure of the air of the first chamber 2128Aa and the pressure of the air of the second chamber 2128Ab decrease.

Similarly, the second movable leg 120B includes a second-movable-leg directional control valve 2126B connected to a second regulator 800B and supplied with the air pressure. The second regulator 800B is accommodated in the moving stand 100. In addition, the second movable leg 120B includes a first-chamber pressure control value 2127Ba that adjusts the air pressure supplied from the second-movable-leg directional control valve 2126B and supplies the adjusted air pressure to a first chamber 212Ba of a second air cylinder 2128B. In addition, the second movable leg 120B includes a second-chamber pressure control value 2127Bb that adjusts the air pressure supplied from the second-movable-leg directional control valve 2126B and supplies the adjusted air pressure to a second chamber 2128Bb of the second air cylinder 2128B. The second air cylinder 2128B includes the first chamber 2128Ba, the second chamber 2128Bb, and a second piston 2128Bp disposed between the first chamber 2128Ba and the second chamber 2128Bb. In addition, a rod (not illustrated) linked with the second piston 2128Bp is linked with a contact portion (not illustrated) of the second movable leg 120B such that the rod can be driven by the contact portion. That is, the second piston 2128Bp causes the second air cylinder 2128B to transmit the load to the floor 2. In the second air cylinder 2128B configured in this manner, the rigidity increases if the pressure of the air of the first chamber 2128Ba and the pressure of the air of the second chamber 2128Bb increase (the air of the first chamber 2128Ba and the air of the second chamber 2128Bb face each other), and decreases if the pressure of the air of the first chamber 2128Ba and the pressure of the air of the second chamber 2128Bb decrease.

Similarly, the third movable leg 120C includes a third-movable-leg directional control valve 2126C connected to a third regulator 800C and supplied with the air pressure. The third regulator 800C is accommodated in the moving stand 100. In addition, the third movable leg 120C includes a first-chamber pressure control value 2127Ca that adjusts the air pressure supplied from the third-movable-leg directional control valve 2126C and supplies the adjusted air pressure to a first chamber 2128Ca of a third air cylinder 2128C. In addition, the third movable leg 120C includes a second-chamber pressure control value 2127Cb that adjusts the air pressure supplied from the third-movable-leg directional control valve 2126C and supplies the adjusted air pressure to a second chamber 2128Cb of the third air cylinder 2128C. The third air cylinder 2128C includes the first chamber 2128Ca, the second chamber 2128Cb, and a third piston 2128Cp disposed between the first chamber 2128Ca and the second chamber 2128Cb. In addition, a rod (not illustrated) linked with the third piston 2128Cp is linked with a contact portion (not illustrated) of the third movable leg 120C such that the rod can be driven by the contact portion. That is, the third piston 2128Cp causes the third air cylinder 2128C to transmit the load to the floor 2. In the third air cylinder 2128C configured in this manner, the rigidity increases if the pressure of the air of the first chamber 2128Ca and the pressure of the air of the second chamber 2128Cb increase (the air of the first chamber 2128Ca and the air of the second chamber 2128Cb face each other), and decreases if the pressure of the air of the first chamber 2128Ca and the pressure of the air of the second chamber 2128Cb decrease.

As illustrated in FIG. 17, the gyrosensor 600Z is connected to the CPU 201 of the robot controller 200 so that the gyrosensor 600Z can output the angular velocity data, detected by the gyrosensor 600Z, to the CPU 201. In addition, the CPU 201 is connected to the first-movable-leg directional control valve 2126A, the second-movable-leg directional control valve 2126B, and the third-movable-leg directional control valve 2126C so that the CPU 201 can output instruction signals to the valves. In addition, the CPU 201 is also connected to the first-chamber pressure control value 2127Aa and the second-chamber pressure control value 2127Ab, used for the first movable leg, so that the CPU 201 can output instruction signals to the valves. In addition, the CPU 201 is also connected to the first-chamber pressure control value 2127Ba and the second-chamber pressure control value 2127Bb, used for the second movable leg, so that the CPU 201 can output instruction signals to the valves. Furthermore, the CPU 201 is also connected to the first-chamber pressure control value 2127Ca and the second-chamber pressure control value 2127Cb, used for the third movable leg, so that the CPU 201 can output instruction signals to the valves.

In each of the first movable leg 120A, the second movable leg 120B, and the third movable leg 120C, the CPU 201 instructs a corresponding directional control valve, a corresponding first-chamber pressure control value, and a corresponding second-chamber pressure control value. As a result, the rigidity produced by each of the first air cylinder 2128A, the second air cylinder 2128B, and the third air cylinder 2128C is changed. Thus, the rigidity of each of the movable legs 120 is changed, so that the fixing holding-force to the floor 2 is changed.

### Posture Control

As illustrated in FIG. 18, after the CPU 201 starts the posture control (which serves also as vibration suppression control in the fourth embodiment), the CPU 201 performs the calibration of the gyrosensor 600Z (S401). That is, in a state where the robot arm 10A is located in an initial position, the CPU 201 performs the initial setting, determining that the tilt of the moving stand 100 is an initial position. Then the CPU 201 controls the first-movable-leg directional control valve 2126A, the second-movable-leg directional control valve 2126B, and the third-movable-leg directional control valve 2126C so that the valves are positioned on a side (i.e., a non-holding side) on which the first movable leg 120A, the second movable leg 120B, and the third movable leg 120C do not output the pressing force. With this operation, the CPU 201 performs the initial setting for the first-movable-leg directional control valve 2126A, the second-movable-leg directional control valve 2126B, and the third-movable-leg directional control valve 2126C (S402). In addition, the CPU 201 controls the second-chamber pressure control value 2127Ab of the first movable leg 120A, the second-chamber pressure control value 2127Bb of the second movable leg 120B, and the second-chamber pressure control value 2127Cb of the third movable leg 120C. That is, the CPU 201 sets a medium pressure, as the initial pressure, in the second chamber 2128Ab of the first air cylinder 2128A, the second chamber 2128Bb of the second air cylinder 2128B, and the second chamber 2128Cb of the third air cylinder 2128C (S403). Then the CPU 201 waits until the CPU 201 determines the start of the posture control (S404: N). After that, the CPU 201 determines the start of the actual operation of the posture control, based on the determination of the start of driving the robot arm 10A for example (S404: Y).

The CPU 201 then sets the pressure of the second chamber 2128Ab of the first air cylinder 2128A, the second chamber 2128Bb of the second air cylinder 2128B, and the second chamber 2128Cb of the third air cylinder 2128C to a low pressure (S405). Furthermore, the CPU 201 also sets the pressure of the first chamber 2128Aa of the first air cylinder 2128A, the first chamber 2128Ba of the second air cylinder 2128B, and the first chamber 2128Ca of the third air cylinder 2128C to a low pressure (S406). Then the CPU 201 controls the first-movable-leg directional control valve 2126A, the second-movable-leg directional control valve 2126B, and the third-movable-leg directional control valve 2126C so that the valves are positioned on a side (i.e., a large-holding-force side) on which the first movable leg 120A, the second movable leg 120B, and the third movable leg 120C output the pressing force (S407). With this operation, the state of the first movable leg 120A, the second movable leg 120B, and the third movable leg 120C is set to a state where the movable legs have lower rigidity to the floor 2. Then the CPU 201 reads the value detected by the gyrosensor 600Z (S408), and calculates a Z coordinate (i.e., a position in the up-and-down direction) of the moving stand 100.

Then the CPU 201 determines in S409, depending on the result detected by the gyrosensor 600Z, whether the position of the whole of the moving stand 100 is lower than the position (i.e., the Z coordinate) of the moving stand 100 obtained in the calibration, that is, in the initial setting performed in the above-described Step S401. If the moving stand 100 is not lower than the position (S409: N), then the CPU 201 determines whether the moving stand 100 is higher than the position (S412). If the moving stand 100 is not higher than the position (S412: N), then the CPU 201 proceeds to Step S415 because the moving stand 100 is not moving in the up-and-down direction. Then the CPU 201 determines whether to end the posture control (S415). That is, the CPU 201 determines whether the drive (work) of the robot arm 10A is completed, and if the robot arm 10A is being driven, then the CPU 201 determines to continue the posture control (S415: N) and returns to Step S408.

If the robot arm 10A is driven, for example, for performing work and the whole of the moving stand 100 has lowered, then the CPU 201 determines that the moving stand 100 has lowered, based on the angular velocity detected by the gyrosensor 600Z (S409: Y). In this case, the CPU 201 instructs the first-movable-leg directional control valve 2126A, the second-movable-leg directional control valve 2126B, and the third-movable-leg directional control valve 2126C so that the valves are positioned on a side (i.e., a large-holding-force side) on which the rigidity of the first movable leg 120A, the second movable leg 120B, and the third movable leg 120C is increased (S410). Then, the CPU 201 controls the first-chamber pressure control value 2127Aa of the first movable leg 120A, the first-chamber pressure control value 2127Ba of the second movable leg 120B, and the first-chamber pressure control value 2127Ca of the third movable leg 120C. That is, the CPU 201 increases the pressure of the first chamber 2128Aa of the first air cylinder 2128A, the first chamber 2128Ba of the second air cylinder 2128B, and the first chamber 2128Ca of the third air cylinder 2128C (S411) (holding-force changing process). That is, the CPU 201 detects that the position and posture of the robot arm 10A has changed and the moving stand 100 has moved downward. Thus, for moving the moving stand 100 toward the opposite direction and preventing the moving stand 100 from moving downward, the CPU 201 decreases the force that moves the moving stand 100 downward, by increasing the rigidity of the first movable leg 120A, the second movable leg 120B, and the third movable leg 120C. In this manner, it becomes possible to prevent the robot system 1 from moving downward.

If the robot arm 10A is driven, for example, for performing work and the whole of the moving stand 100 has moved up, the CPU 201 determines that the moving stand 100 has moved up, based on the angular velocity detected by the gyrosensor 600Z (S412: Y). In this case, the CPU 201 instructs the first-movable-leg directional control valve 2126A, the second-movable-leg directional control valve 2126B, and the third-movable-leg directional control valve 2126C so that the valves are positioned on a side (i.e., a small-holding-force side) on which the rigidity of the first movable leg 120A, the second movable leg 120B, and the third movable leg 120C is decreased (S413). Then, the CPU 201 controls the second-chamber pressure control value 2127Ab of the first movable leg 120A, the second-chamber pressure control value 2127Bb of the second movable leg 120B, and the second-chamber pressure control value 2127Cb of the third movable leg 120C. That is, the CPU 201 increases the pressure of the second chamber 2128Ab of the first air cylinder 2128A, the second chamber 2128Bb of the second air cylinder 2128B, and the second chamber 2128Cb of the third air cylinder 2128C (S414) (holding-force changing process). That is, the CPU 201 detects that the position and posture of the robot arm 10A has changed and the moving stand 100 has moved upward. Thus, for moving the moving stand 100 toward the opposite direction and preventing the moving stand 100 from moving upward, the CPU 201 decreases the force that moves the moving stand 100 upward, by decreasing the rigidity of the first movable leg 120A, the second movable leg 120B, and the third movable leg 120C. That is, the CPU 201 makes it difficult for the first movable leg 120A, the second movable leg 120B, and the third movable leg 120C to float up from the floor 2. In this manner, it becomes possible to prevent the robot system 1 from moving upward.

Thus, every time the movement of the moving stand 100 in the up-and-down direction is detected, the CPU 201 suppresses the movement of the moving stand 100 in the up-and-down direction by controlling the fixing holding-force of the first movable leg 120A, the second movable leg 120B, and the third movable leg 120C to the floor 2. With this operation, the fixing holding-force of the first movable leg 120A, the second movable leg 120B, and the third movable leg 120C to the floor 2 is produced also for the vibration of the moving stand 100, produced in the up-and-down direction and caused by the motion of the robot arm 10A, for suppressing the vibration. Thus, it is possible to suppress the vibration of the moving stand 100, especially in the Z direction.

Note that if the CPU 201 determines that the drive (work) of the robot arm 10A is completed, then the CPU 201 determines to end the posture control (S415: Y) and ends the posture control of the present embodiment.

### Summary of Fourth Embodiment

As described above, also in the robot system 1 of the fourth embodiment, in a case where the robot system 1 (or the moving stand 100) is moved, the robot system 1 can be installed by only lifting the casters 191 and causing the fixed legs 110 and the movable legs 120 to contact the floor 2. That is, since the first air cylinder 2128A, the second air cylinder 2128B, and the third air cylinder 2128C that can change the fixing holding-force to the floor 2 are disposed in the movable legs 120, it is possible to suppress the vibration of the robot system 1, which is caused by the motion of the robot arm 10A. Thus, the robot system 1 (especially the robot arm 10A) can be stabilized in a place where the robot system 1 is installed, and the need for firmly fixing the robot system 1 to the floor 2 can be eliminated. Thus, in a case where the robot system 1 (or the moving stand 100) is moved, the robot system 1 can be easily installed in a place where the robot system 1 is installed, and the time required for the start of work can be shortened.

Note that since other configurations, operations, and effects of the above-described fourth embodiment are the same as those of the above-described third embodiment, the description thereof will be omitted.

### Fifth Embodiment

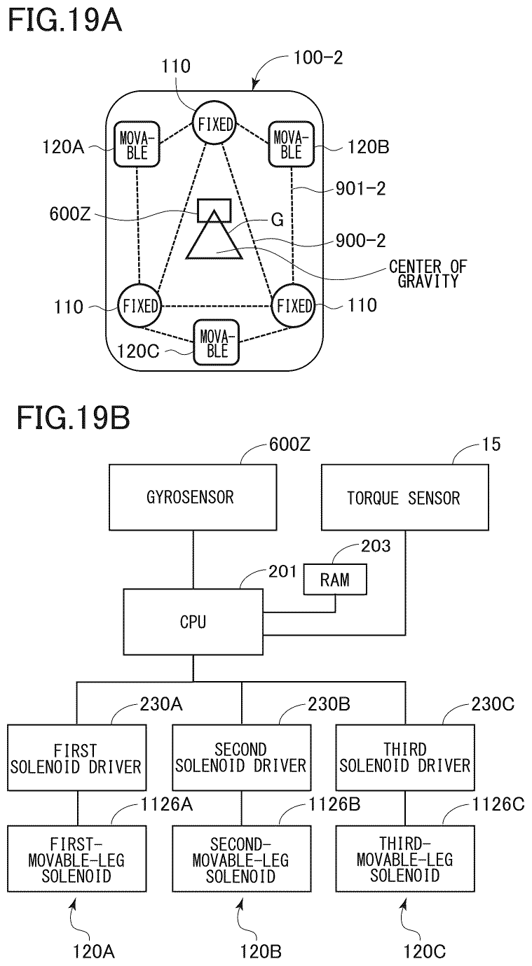

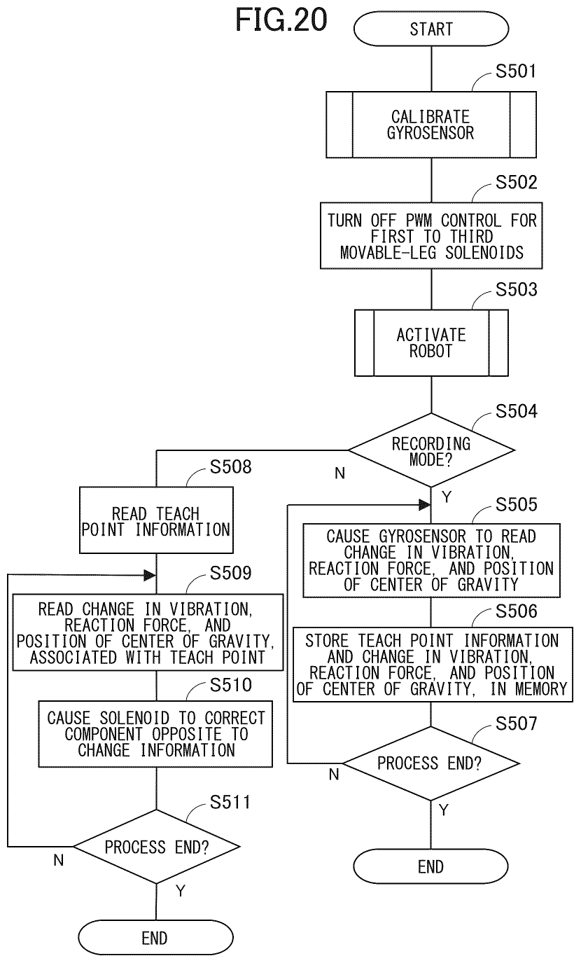

Next, a fifth embodiment will be described with reference to FIGS. 19 and 20. In the fifth embodiment, part of the above-described third embodiment is changed. FIG. 19A is a diagram illustrating positions in which fixed legs, movable legs, and a gyrosensor of the fifth embodiment are disposed. FIG. 19B is a block diagram illustrating a control system of the movable legs of the fifth embodiment. FIG. 20 is a flowchart illustrating initial setting control and correction control of the fifth embodiment.

In the fifth embodiment, the amount of change of the moving stand 100 caused by the test operation of the robot arm 10A is measured and stored, and the magnitude of the fixing holding-force of the movable leg 120 is controlled in accordance with the amount of change stored. As in the third embodiment, in the fifth embodiment, the magnitude of the fixing holding-force of the movable leg 120 is changed by using the magnetic force generated by a solenoid. The fixing holding-force of the movable leg 120 is changed by changing the magnetic force generated by the solenoid, so that the vibration of the moving stand 100 in the up-and-down direction is suppressed. Note that also in the fifth embodiment, the floor 2 is made of a magnetic material, and the floor 2 and the movable leg 120 are caused to magnetically stick to each other, by the magnetic force. Hereinafter, the initial setting control and the correction control of the fifth embodiment will be described.

### Configuration of Moving Stand

As illustrated in FIGS. 19A and 19B, the configuration of the moving stand 100 of the fifth embodiment and the configuration of the first movable leg 120A, the second movable leg 120B, and the third movable leg 120C are basically the same as those of the above-described third embodiment. In addition, as illustrated in FIG. 19B, the CPU 201 is connected with a torque sensor 15 that serves as a detection portion disposed in each joint of the robot arm 10A. In addition, the amount of change of the moving stand 100 calculated by the CPU 201 based on the value detected by the gyrosensor 600Z can be stored in the RAM 203.

### Initial Setting Control

As illustrated in FIG. 20, after the CPU 201 starts the control, the CPU 201 performs the calibration of the gyrosensor 600Z (S501). That is, in a state where the robot arm 10A is located in an initial position, the CPU 201 performs the initial setting, determining that the tilt of the moving stand 100 is an initial position. Then the CPU 201 turns the PWM control OFF (S502) (the PWM control is performed on the first-movable-leg solenoid 1126A, the second-movable-leg solenoid 1126B, and the third-movable-leg solenoid 1126C). That is, the CPU 201 performs the initial setting of the first-movable-leg solenoid 1126A, the second-movable-leg solenoid 1126B, and the third-movable-leg solenoid 1126C. Then the CPU 201 activates the robot arm (robot) 10A (S503), and determines whether the activation has been performed in a recording mode for a test operation, or in another mode, other than the recording mode, for the normal operation (S504). If the activation of the robot arm 10A has been performed for the test operation, then the CPU 201 determines the mode as the recording mode (S504: Y) and proceeds to Step S505. That is, the CPU 201 performs the initial setting control (i.e., the control of the recording mode) in steps S505 to S507.

That is, in the test operation, the CPU 201 drives the robot arm 10A in the same trajectory and posture as those in the normal operation but does not cause the robot arm 10A to perform work on a workpiece. In the test operation, the CPU 201 reads the result detected by the gyrosensor 600Z, while associating the result with the teach point information of the robot arm 10A (S505). That is, the CPU 201 reads values for detecting the change in vibration, reaction force, and the position of the center of gravity, which is produced in the moving stand 100 in accordance with the trajectory and posture of the robot arm 10A. Note that the teach point information is information on coordinates and the like, which is stored associated with the pass point of the robot arm 10A when a user teaches the robot the trajectory and posture for the work of the robot arm 10A, by using a teaching pendant or the like.

That is, the CPU 201 calculates the vibration, the reaction force, and the position of the center of gravity, produced in the moving stand 100, based on the result detected by the gyrosensor 600Z; associates the vibration, the reaction force, and the position of the center of gravity with the trajectory and posture of the robot arm 10A; and records the associated data in the RAM (memory) 203, as the amount of change (S506). Then the CPU 201 determines whether the process of the test operation of the robot arm 10A is completed (S507), and if the process is not completed, the CPU 201 continues to perform the above-described recording operation (S507: N). After that, if the process of the test operation of the robot arm 10A is completed (S507: Y), then the CPU 201 ends the above-described recording operation. That is, the CPU 201 ends the initial setting control (i.e., the control of the recording mode).

### Correction Control

Next, the correction control performed not for the test operation but for the actual operation of the robot arm 10A will be described. As illustrated in FIG. 20, after the CPU 201 starts the control, the CPU 201 performs the calibration of the gyrosensor 600Z, as described above (S501). That is, in a state where the robot arm 10A is located in an initial position, the CPU 201 performs the initial setting, determining that the tilt of the moving stand 100 is an initial position. Then the CPU 201 turns the PWM control OFF (S502) (the PWM control is performed on the first-movable-leg solenoid 1126A, the second-movable-leg solenoid 1126B, and the third-movable-leg solenoid 1126C). That is, the CPU 201 performs the initial setting of the first-movable-leg solenoid 1126A, the second-movable-leg solenoid 1126B, and the third-movable-leg solenoid 1126C. Then the CPU 201 activates the robot arm (robot) 10A (S503), and determines whether the activation has been performed in the recording mode for the test operation, or in another mode, other than the recording mode, for the normal operation (S504). If the activation of the robot arm 10A has been performed not for the test operation but for the actual operation, then the CPU 201 determines the mode as a mode other than the recording mode (S504: N) and proceeds to Step S508. That is, the CPU 201 performs the correction control in steps S508 to S511.

In the correction control, the CPU 201 reads the above-described teach point information from the RAM 203 or the like (S508). The CPU 201 reads the data on the amount of change in the vibration, the reaction force, and the position of the center of gravity that was associated with the motion (teach points) of the robot arm 10A and stored in the test operation in the above-described Step S506 (S509). Then the CPU 201 controls the first-movable-leg solenoid 1126A, the second-movable-leg solenoid 1126B, and the third-movable-leg solenoid 1126C in synchronization with the timing of the motion of the robot arm 10A (i.e., the timing at which the robot arm 10A passes the teach point). That is, the CPU 201 controls the output of the magnetic sticking force of the first-movable-leg solenoid 1126A, the second-movable-leg solenoid 1126B, and the third-movable-leg solenoid 1126C, in synchronization with the timing of the motion of the robot arm 10A, so that the magnetic sticking force is outputted in a direction (i.e., an opposite direction) in which the above-described amount of change (i.e., change information) is canceled (S510) (holding-force changing process). Then the CPU 201 determines whether the process of the work of the robot arm 10A is completed (S511), and if the process is not completed, the CPU 201 continues to perform the above-described correcting operation (S511: N). After that, if the process of the normal operation of the robot arm 10A is completed (S511: Y), then the CPU 201 ends the above-described correction control.

### Summary of Fifth Embodiment

As described above, in the robot system 1 of the fifth embodiment, the fixing holding-force of the first movable leg 120A, the second movable leg 120B, and the third movable leg 120C can be controlled by using the feedforward control, based on the amount of change stored in the test operation. That is, the vibration, the reaction force, and the movement of the center of gravity, produced in the moving stand 100, can be more effectively canceled, compared with those in a case where the feedback control is performed, as in the first to the fourth embodiments, in accordance with the result detected by the gyrosensor. Note that the feedforward control may be combined with the feedback control.

In addition, also in the robot system 1 of the fifth embodiment, in a case where the robot system 1 (or the moving stand 100) is moved, the robot system 1 can be installed by only lifting the casters 191 and causing the fixed legs 110 and the movable legs 120 to contact the floor 5. That is, since the first-movable-leg solenoid 1126A, the second-movable-leg solenoid 1126B, and the third-movable-leg solenoid 1126C that can change the fixing holding-force to the floor 2 are disposed in the movable legs 120, it is possible to suppress the vibration, the tilt, and the fall over of the robot system 1 that are caused by the motion of the robot arm 10A. Thus, the robot system 1 (especially the robot arm 10A) can be stabilized in a place where the robot system 1 is installed, and the need for firmly fixing the robot system 1 to the floor 2 can be eliminated. Thus, in a case where the robot system 1 (or the moving stand 100) is moved, the robot system 1 can be easily installed in a place where the robot system 1 is installed, and the time required for the start of work can be shortened.

Note that since other configurations, operations, and effects of the above-described fifth embodiment are the same as those of the above-described third embodiment, the description thereof will be omitted.

### Sixth Embodiment

Next, a sixth embodiment will be described. In the sixth embodiment, part of the above-described first to the fifth embodiments is changed. In the sixth embodiment, the configuration (i.e., the air sticking portion, the solenoid, the air cylinder, or the like) that actively changes the fixing holding-force is not disposed in the movable leg 120. Instead, a configuration that passively changes the fixing holding-force is disposed in the movable leg 120.

In a case where a robot that is not moved is incorporated in a production line and fixed onto the production line, a high-strength metal plate is often used as a spacer, and is fixed via a rigid body. However, in the case of the robot arm 10A mounted on the moving stand 100, the moving stand 100 and the robot arm 10A are firmly fixed to each other. Thus, the impact of vibration caused when the moving stand 100 is moved and the casters 191 climb over a step may be directly transmitted to the robot arm 10A, so that each joint of the robot arm 10A may be damaged. In addition, if the fixing force to the floor 2 is produced, as in the first to the third embodiments and the fifth embodiment, by using the air sticking force or the magnetic force, the robot arm 10A will be vibrated easily because the fixing force is smaller than that in the mechanical fixing that uses an anchor or the like.

Thus, in the sixth embodiment, a damper member (or a damper mechanism) not illustrated and having a vibration-isolating function, a vibration-removing function, or a vibration-damping function is disposed in the movable leg 120 for suppressing the vibration of the moving stand 100 in the operation (assembly operation) of the robot arm 10A. That is, the damper member changes the magnitude of the fixing holding-force by changing the damping force in accordance with the speed at which the load is applied to the movable leg 120. Thus, even if the impact is caused by a step when the moving stand 100 is moved, the damper member can effectively reduce the impact. Note that the damper member may be a gel-like sheet made of a vibration-isolating material.

In addition, also in the robot system 1 of the sixth embodiment, in a case where the robot system 1 (or the moving stand 100) is moved, the robot system 1 can be installed by only lifting the casters 191 and causing the fixed legs 110 and the movable legs 120 to contact the floor 2. That is, since the damper member that can change the fixing holding-force to the floor 2 is disposed in the movable leg 120, it is possible to suppress the vibration, the tilt, and the fall over of the robot system 1 that are caused by the motion of the robot arm 10A. Thus, the robot system 1 (especially the robot arm 10A) can be stabilized in a place where the robot system 1 is installed, and the need for firmly fixing the robot system 1 to the floor 2 can be eliminated. Thus, in a case where the robot system 1 (or the moving stand 100) is moved, the robot system 1 can be easily installed in a place where the robot system 1 is installed, and the time required for the start of work can be shortened.

Note that since other configurations, operations, and effects of the above-described sixth embodiment are the same as those of the above-described first to the fifth embodiments, the description thereof will be omitted.

### OTHER EMBODIMENTS

In the above-described first and the second embodiments, the CPU 201 calculates the tilt of the moving stand 100, based on the result detected by the gyrosensor. However, the present disclosure is not limited to this. For example, the gyrosensor may detect the angular velocity for detecting the center G of gravity, and the CPU 201 may calculate the position of the center G of gravity, and control the magnitude of the fixing holding-force of the movable leg in accordance with the position of the center G of gravity. In another case, the first and the second embodiments may be combined with the third to the fifth embodiments. That is, the gyrosensor that detects the tilt may also detect the vibration. Specifically, the CPU 201 may calculate the tilt and the vibration of the moving stand 100 from the value detected by the gyrosensor, and control the magnitude of the fixing holding-force of the movable leg in accordance with the tilt and the vibration.

In the first to the fifth embodiments, the description has been made, as an example, for the gyrosensor that serves as a sensor for detecting the tilt and the vibration. However, the present disclosure is not limited to this. For example, another sensor may be used for detecting the tilt, the center of gravity, or the vibration. For example, a value from a torque sensor disposed in each joint of the robot arm 10A may be used. Furthermore, a velocity sensor for detecting the velocity of the moving stand 100, an acceleration sensor for detecting the acceleration of the moving stand 100, or a current detecting element for detecting the current that changes in accordance with the change (vibration) of the moving stand 100 may be disposed in the moving stand 100.

In the first to the fourth embodiments, the description has been made for the case where the tilt of the moving stand 100, the center of gravity of the robot arm 10A, the vibration of the moving stand 100, and the like are detected, based on the result detected by a sensor such as a gyrosensor. However, the present disclosure is not limited to this. For example, the above-described tilt, center of gravity, vibration, and the like may be calculated, based on the trajectory and posture (i.e., teach point information) of the robot arm 10A that are predetermined in accordance with the work of the robot arm 10A. That is, in this case, a configuration in which the sensor is not disposed in the moving stand 100 and the fixing holding-force of the movable leg is changed by only the computation by the robot controller 200 is included.

In the first to the sixth embodiments, the holding-force changing portion, such as the air sticking portion, the solenoid, the air cylinder, or the vibration-isolating material, that changes the fixing holding-force is disposed in the movable leg 120. However, the holding-force changing portion may be disposed not in the movable leg 120, but in the fixed leg 110. That is, the holding-force changing portion has only to be disposed in at least one of the plurality of legs. In particular, in this case, all of the plurality of legs may be the fixed legs or the movable legs.

In the first and the fourth embodiments, the description has been made for the configuration where the air pressure from the regulator is supplied to the pressure control valve. However, an accumulator may be disposed between the regulator and the pressure control valve for increasing the responsivity of supplying the pressure.

In the first to the sixth embodiments, the description has been made, as an example, for the case where the robot system 1 performs work, such as the work for assembling a pin to an assembly workpiece or the work for assembling a connector to a board. However, the work performed by the robot system 1 is not limited to the above-described work. That is, the robot system 1 may perform any work.

The present disclosure is not limited to the above-described embodiments, and may be variously modified within the technical concept of the present disclosure. For example, at least two of the above-described plurality of embodiments and modifications may be combined with each other. In addition, the effects described in the embodiments are merely the most suitable effects produced by the embodiments of the present disclosure. Thus, the effects by the embodiments of the present disclosure are not limited to those described in the embodiments.

In the above-described first to sixth embodiments, the description has been made for the case where the robot body (or simply a robot) is a vertically articulated robot. However, the present disclosure is not limited to this. For example, the robot body (or simply a robot) may be a horizontally articulated robot, a parallel link robot, or a Cartesian coordinate robot. In addition, the above-described embodiments can be applied to any machine that can automatically perform expansion and contraction motion, bending and stretching motion, up-and-down motion, right-and-left motion, pivot motion, or combination motion thereof, depending on the information data stored in a storage device of a control apparatus.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-153958, filed Sep. 20, 2023, which is hereby incorporated by reference herein in its entirety.

What is claimed is:

1. A robot system comprising:
a robot; and
a moving stand including a plurality of legs configured to contact a floor or a ground, and an installation portion on which the robot is installed,
wherein at least one of the plurality of legs includes a holding-force changing portion configured to change fixing holding-force between the at least one of the plurality of legs and the floor or the ground in accordance with state of the robot.

2. The robot system according to claim 1, wherein the moving stand includes a frame portion to which the plurality of legs is attached, and
wherein the plurality of legs includes at least one fixed leg whose length in an up-and-down direction is not able to be changed with respect to the frame portion, and at least one movable leg whose length in the up-and-down direction is able to be changed with respect to the frame portion.

3. The robot system according to claim 2, wherein the holding-force changing portion is disposed in the movable leg.

4. The robot system according to claim 3, wherein the at least one fixed leg includes three or more fixed legs and the at least one movable leg includes two or more movable legs,
wherein when viewed from the up-and-down direction, the installation portion is disposed inside a figure formed by connecting the three or more fixed legs that serve as apexes, with a line, and
wherein the two or more movable legs are disposed outside the figure.

5. The robot system according to claim 1, further comprising a control portion configured to control a magnitude of the fixing holding-force of the holding-force changing portion.

6. The robot system according to claim 5, wherein the holding-force changing portion is an air sticking portion configured to change the magnitude of the fixing holding-force by changing sticking force to the floor or the ground by using air.

7. The robot system according to claim 5, wherein the holding-force changing portion is a magnetic-force sticking portion configured to change the magnitude of the fixing holding-force by changing sticking force to the floor or the ground by using magnetic force.

8. The robot system according to claim 5, wherein the holding-force changing portion is an air cylinder configured to change the fixing holding-force by changing rigidity.

9. The robot system according to claim 6, further comprising a detection portion configured to detect change in state of the moving stand, the state changing in accordance with position and posture of the robot,
wherein the control portion is configured to control the magnitude of the fixing holding-force of the holding-force changing portion in accordance with a result detected by the detection portion.

10. The robot system according to claim 9, wherein the control portion is configured to control the magnitude of the fixing holding-force of the holding-force changing portion in accordance with change in position of a center of gravity of the moving stand that is determined based on a result detected by the detection portion.

11. The robot system according to claim 9, wherein the detection portion is configured to detect vibration of the moving stand that changes in accordance with the position and posture of the robot, and
wherein the control portion is configured to control the magnitude of the fixing holding-force of the holding-force changing portion in accordance with the vibration detected by the detection portion.

12. The robot system according to claim 9, wherein the detection portion includes at least one of a torque sensor disposed in a joint of the robot, a gyrosensor disposed in the moving stand, a velocity sensor disposed in the moving stand, an acceleration sensor disposed in the moving stand, a current detecting element disposed in the moving stand and configured to detect current that changes in accordance with movement of the moving stand.

13. The robot system according to claim 5, wherein the control portion is configured to store an amount of change in state produced in the moving stand in a case where a test operation of work is executed by the robot, and control the magnitude of the fixing holding-force of the holding-force changing portion in accordance with the amount of change stored, in a case where the work is executed by the robot.

14. The robot system according to claim 1, wherein the holding-force changing portion is a damper member configured to change a magnitude of the fixing holding-force by changing damping force in accordance with speed at which load is applied to the legs.

15. The robot system according to claim 1, further comprising a vibration-isolating mechanism, a vibration-removing mechanism, or a vibration-damping mechanism disposed between the installation portion of the moving stand and the robot.

16. The robot system according to claim 1, wherein the moving stand includes
a caster configured to move the moving stand by rolling, and
a switching mechanism configured to switch position of the caster between a projecting position at which the caster projects downward from the legs and a retracted position at which the caster is retracted upward from the legs.

17. A method of controlling a robot system, the method comprising:
providing a robot system including
a robot,
a moving stand including a plurality of legs which is configured to contact a floor or a ground, and an installation portion on which the robot is installed,
a control portion, and
a holding-force changing portion disposed in at least one of the plurality of legs and configured to change fixing holding-force between the at least one of plurality of legs and the floor or the ground; and
controlling, by the control portion, a magnitude of the fixing holding-force of the holding-force changing portion in accordance with state of the robot.

18. A moving stand on which a robot is installed and that is configured to move with respect to a floor or a ground, the moving stand comprising:
a plurality of legs configured to contact the floor or the ground,
wherein at least one of the plurality of legs includes a holding-force changing portion configured to change fixing holding-force between at least one of the plurality of legs and the floor or the ground in accordance with state of the robot.

19. A method of controlling a moving stand configured to move with respect to a floor or the ground, the method comprising:
providing the moving stand including
a plurality of legs configured to contact the floor or a ground,
an installation portion on which a robot is installed,
a holding-force changing portion disposed in at least one of the plurality of legs and configured to change fixing holding-force between the at least one of the plurality of legs and the floor or the ground, and
a control portion; and
controlling, by the control portion, a magnitude of the fixing holding-force of the holding-force changing portion in accordance with state of the robot.

20. A method of manufacturing products by using the robot system according to claim 1.

21. A computer-readable non-transitory recording medium storing a program that causes a computer to perform the control method of a robot system according to claim 17.
